(19) United States
(12) Patent Application Publication
(10) Pub. No.: US 2021/0181767 A1
(43) Pub. Date: Jun. 17, 2021

(54) UNMANNED AERIAL VEHICLE CONTROL METHODS AND SYSTEMS, AND UNMANNED AERIAL VEHICLES

(71) Applicant: SZ DJI TECHNOLOGY CO., LTD., Shenzhen (CN)

(72) Inventors: Yang LI, Shenzhen (CN); Zhenhao ZHOU, Shenzhen (CN); Ye TAO, Shenzhen (CN)

(73) Assignee: SZ DJI TECHNOLOGY CO., LTD., Shenzhen (CN)

(21) Appl. No.: 17/155,030

(22) Filed: Jan. 21, 2021

Related U.S. Application Data
(63) Continuation of application No. PCT/CN2018/097023, filed on Jul. 25, 2018.

(51) Int. Cl. G05D 1/10; G05D 1/08; G05D 1/00; G08G 5/00; B64C 39/02; B64D 45/00; F16M 11/12

(52) U.S. Cl. CPC G05D 1/106; G05D 1/0808; G05D 1/0016; G08G 5/0069; B64C 2201/145; B64D 45/00; F16M 11/123; B64D 2045/0085; B64C 39/024

(57) ABSTRACT

A method for controlling an unmanned aerial vehicle control includes: obtaining sensing information of the unmanned aerial vehicle, wherein the sensing information includes at least one of status information or environment information; obtaining at least one control mode; calling and/or invoking at least one execution device in the at least one control mode; generating a control instruction based on the at least one control mode and a sensing value of the sensing information; sending the control instruction to the at least one execution device; receiving, by the at least one execution device, the control instruction; and performing, by the at least one execution device, a corresponding action based on the control instruction. Intelligent outputting of the execution device may be achieved by intelligently integrating a plurality of sensing assemblies of the unmanned aerial vehicle and obtaining corresponding control modes.

### RELATED APPLICATIONS

The present patent document is a continuation of PCT Application Ser. No. PCT/CN2018/097023, filed on Jul. 25, 2018, designating the United States, published in Chinese, content of which is incorporated herein by reference in its entirety.

### BACKGROUND

### 1. Technical Field

The present disclosure relates to the field of unmanned aerial vehicles, and in particular, to unmanned aerial vehicle control methods and systems, and unmanned aerial vehicles.

### 2. Background Information

In conventional techniques, unmanned aerial vehicles have been extensively applied in scenarios such as aerial photographing, agriculture, plant protection, self-photographing, film/television shooting, express delivery, and disaster rescue. Currently, main optical systems of an unmanned aerial vehicle include a camera of a photographing system, a vision sensor of an obstacle avoidance system, a signal indicator system for representing a flight status of the unmanned aerial vehicle, and the like. The systems generally exist independently. For example, the information in a sensing assembly is basically a binocular depth map or main camera information, and a corresponding execution device adjusts a plane posture or outputs a signal of a signal indicator. Various modules are not systematically applied in the existing unmanned aerial vehicle in a centralized manner, resulting in a lack of systematic and intelligent interaction application scenarios.

### BRIEF SUMMARY

The present disclosure provides methods and systems for controlling an unmanned aerial vehicle, and unmanned aerial vehicles that can make an execution device output intelligently by intelligently integrating a plurality of sensing assemblies of the unmanned aerial vehicle and obtaining corresponding control modes, such that customer experiences may be improved.

A first aspect of the present disclosure refers to an unmanned aerial vehicle control method applied to an unmanned aerial vehicle. The unmanned aerial vehicle control method may comprise: obtaining sensing information of the unmanned aerial vehicle, wherein the sensing information includes at least one of status information of the unmanned aerial vehicle or environment information of the unmanned aerial vehicle; obtaining at least one control mode; calling at least one execution device in the at least one control mode; generating a control instruction based on the at least one control mode and a sensing value of the sensing information; sending the control instruction to the at least one execution device; receiving, by the at least one execution device, the control instruction; and performing, by the at least one execution device, a corresponding action based on the control instruction.

A second aspect of the present disclosure refers to an unmanned aerial vehicle control system. The unmanned aerial vehicle control system may comprise: a sensing assembly to obtain sensing information of the unmanned aerial vehicle, wherein the sensing information includes at least one of status information or environment information; and a processor, configured to obtain at least one control mode, call at least one execution device based on the at least one control mode, generate a control instruction based on the at least one control mode and a sensing value of the sensing information, and send the control instruction to the at least one execution device such that the at least one execution device performs a corresponding action based on the control instruction.

A third aspect of the present disclosure refers to an unmanned aerial vehicle. The unmanned aerial vehicle may comprise: a fuselage; an unmanned aerial vehicle control system disposed on the fuselage; and at least one execution device disposed on the fuselage, wherein the unmanned aerial vehicle control system includes: a sensing assembly to obtain sensing information of the unmanned aerial vehicle, wherein the sensing information includes at least one of status information or environment information, and a processor, configured to obtain at least one control mode, generate a control instruction based on the at least one control mode and a sensing value of the sensing information, and call at least one execution device based on the at least one control mode, such that the at least one execution device performs a corresponding action based on the control instruction.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of an unmanned aerial vehicle according to some exemplary embodiments of the present disclosure;

FIG. 2 is a schematic diagram of an unmanned aerial vehicle according to some exemplary embodiments of the present disclosure;

FIG. 3 is a schematic flowchart of an unmanned aerial vehicle control method according to some exemplary embodiments of the present disclosure;

FIG. 4 is a schematic structural diagram of another unmanned aerial vehicle according to some exemplary embodiments of the present disclosure;

FIG. 5 is a schematic flowchart of an unmanned aerial vehicle control method corresponding to the embodiment in FIG. 4;

FIG. 6 is a schematic structural diagram of still another unmanned aerial vehicle according to some exemplary embodiments of the present disclosure;

FIG. 7 is a schematic flowchart of an unmanned aerial vehicle control method corresponding to the embodiment in FIG. 6;

FIG. 8 is a schematic structural diagram of still another unmanned aerial vehicle according to some exemplary embodiments of the present disclosure;

FIG. 9 is a schematic structural diagram of still another unmanned aerial vehicle according to some exemplary embodiments of the present disclosure;

FIG. 10 is a schematic flowchart of an unmanned aerial vehicle control method corresponding to the embodiment in FIG. 9;

FIG. 11 is a schematic structural diagram of still another unmanned aerial vehicle according to some exemplary embodiments of the present disclosure;

FIG. 12 is a schematic flowchart of an unmanned aerial vehicle control method corresponding to the embodiment in FIG. 11;

FIG. 13 is a schematic structural diagram of still another unmanned aerial vehicle according to some exemplary embodiments of the present disclosure;

FIG. 14 is a schematic flowchart of an unmanned aerial vehicle control method corresponding to the embodiment in FIG. 13;

FIG. 15 is a schematic flowchart of still another unmanned aerial vehicle control method according to some exemplary embodiments of the present disclosure;

FIG. 16 is a schematic structural diagram of still another unmanned aerial vehicle according to some exemplary embodiments of the present disclosure;

FIG. 17 is a schematic flowchart of an unmanned aerial vehicle control method corresponding to the embodiment in FIG. 16;

FIG. 18 is a schematic structural diagram of still another unmanned aerial vehicle according to some exemplary embodiments of the present disclosure;

FIG. 19 is a schematic flowchart of an unmanned aerial vehicle control method corresponding to the embodiment in FIG. 18;

FIG. 20 is a schematic structural diagram of still another unmanned aerial vehicle according to some exemplary embodiments of the present disclosure;

FIG. 21 is a schematic structural diagram of still another unmanned aerial vehicle according to some exemplary embodiments of the present disclosure;

FIG. 22 is a schematic flowchart of an unmanned aerial vehicle control method corresponding to the embodiment in FIG. 21;

FIG. 23 is a schematic structural diagram of still another unmanned aerial vehicle according to some exemplary embodiments of the present disclosure;

FIG. 24 is a schematic flowchart of an unmanned aerial vehicle control method corresponding to the embodiment in FIG. 23;

FIG. 25 is a schematic structural diagram of still another unmanned aerial vehicle according to some exemplary embodiments of the present disclosure; and

FIG. 26 is a schematic flowchart of an unmanned aerial vehicle control method corresponding to the embodiment in FIG. 25.

### DETAILED DESCRIPTION OF THE DRAWINGS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in this specification are the same as those generally understood by persons skilled in the art of the present disclosure. The terms used in this specification of the present disclosure herein are used only to describe specific embodiments, and not intended to limit the present disclosure. The term “and/or” used in this specification includes any or all possible combinations of one or more associated listed items.

The following describes in detail some implementations of the present disclosure with reference to the accompanying drawings. Under a condition that no conflict occurs, the following embodiments and features in the embodiments may be mutually combined. The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some exemplary embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some exemplary embodiments, the numerical parameters set forth in the written description and the appended claims are approximations, which may vary depending upon the desired properties sought to be obtained in a particular embodiment. In some exemplary embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

Exemplary embodiments are described in detail herein, and examples of the exemplary embodiments are presented in the accompanying drawings. When the following description relates to the accompanying drawings, unless otherwise specified, same numbers in different accompanying drawings represent same or similar elements. Implementations described in the following exemplary embodiments do not represent all implementations consistent with the present disclosure. On the contrary, they are only examples of apparatuses and methods that are described in detail in the appended claims and are consistent with some aspects of the present disclosure.

The terms used in the present disclosure are used only to describe specific embodiments, and not intended to limit the present disclosure. The terms “a”, “said”, and “the” in singular forms used in the present disclosure and the appended claims are also intended to include plural forms, unless otherwise clearly indicated in a context. It should also be understood that the term “and/or” used in this specification indicates and includes any or all possible combinations of one or more associated listed items.

It should be understood that the terms “first”, “second”, and the like used in this specification and the claims of this application do not indicate any sequence, quantity, or importance, but are used only for distinguishing between different components. Likewise, the terms “a/an” or “one”, and the like do not indicate a quantity limitation either, but indicate that at least one exists. Unless otherwise specified, the terms “before”, “after”, “below”, and/or “above”, and the like are used only for ease of description, and not intended to limit a location or a spatial direction. The terms “comprise” or “include”, and the like are intended to indicate that an element or an object stated before “comprise” or “include” covers an element or an object or any equivalent thereof listed after “comprise” or “include”, but does not exclude other elements or objects. The terms “connection” or “connected”, and the like are not limited to a physical or mechanical connection, but may include an electrical connection, whether direct or indirect.

The following describes in detail some implementations of the present disclosure with reference to the accompanying drawings. Under a condition that no conflict occurs, the following embodiments and features in the embodiments may be mutually combined.

Embodiments of the present disclosure provide an unmanned aerial vehicle control method and system, and an unmanned aerial vehicle. It may be understood that the unmanned aerial vehicle in the present disclosure may be configured to move in any appropriate environment, for example, in the air (for example, an aircraft with fixed wings, an aircraft with rotors, or an aircraft without fixed wings and rotors), in water (for example, a ship or a submarine), on land (for example, a motor vehicle, for example, a car, a truck, a bus, a van, a motorcycle, a bike, or a train), underground (for example, a metro), in space (for example, a space shuttle, a satellite, or a probe), or any combination thereof. The embodiments of the present disclosure are described in detail with reference to accompanying drawings by using an unmanned aerial vehicle as an example.

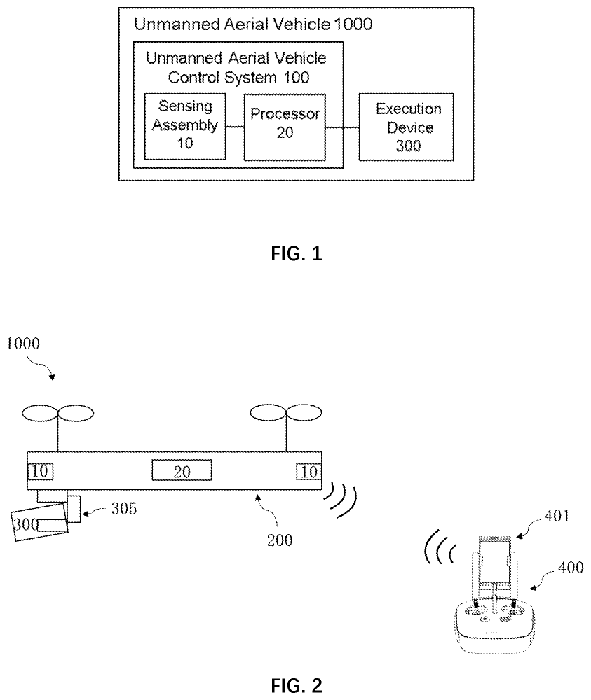

FIG. 1 is a schematic structural diagram of an unmanned aerial vehicle 1000 according to some exemplary embodiments of the present disclosure. FIG. 2 is a schematic diagram of the unmanned aerial vehicle 1000. In some exemplary embodiments, referring to FIG. 1 and FIG. 2, the unmanned aerial vehicle 1000 may include an unmanned aerial vehicle control system 100, a fuselage 200, and at least one execution device 300, where the unmanned aerial vehicle control system 100 may include a sensing assembly 10 and a processor 20. Further, the unmanned aerial vehicle control system 100 and the execution device 300 may be disposed in the fuselage 200 of the unmanned aerial vehicle 1000. For example, in some exemplary embodiments, the fuselage 200 may include a frame and an arm assembly. The unmanned aerial vehicle control system 100 may be disposed on the frame partially or completely. For example, the sensing assembly 10 in the unmanned aerial vehicle control system 100 may be located on the arm assembly, and the processor 20 in the unmanned aerial vehicle control system 100 may be located on the frame. For another example, both the sensing assembly 10 and the processor 20 in the unmanned aerial vehicle control system 100 may be located on the frame. Likewise, the at least one execution device 300 may be disposed on the frame partially or completely, or may be all located on the frame. This is not limited herein.

In some exemplary embodiments, the unmanned aerial vehicle control system 100 may further include a main memory (e.g., read-only memory (ROM), flash memory, dynamic random access memory (DRAM) such as synchronous DRAM (SDRAM)), a static memory (e.g., flash memory, sialic random access memory (SRAM)), and a data storage device, which communicates with each other via a bus. The processor 20 may represent one or more general-purpose processing devices such as a microprocessor, central processing unit, or the like. The processor 20 may be a complex instruction set computing (CISC) microprocessor, reduced instruction set computing (RISC) microprocessor, very long instruction word (VLIVV) microprocessor, or a processor implementing other instruction sets or processors implementing a combination of instruction sets. The processor 20 may also be one or more special-purpose processing devices such as an application-specific integrated circuit (ASIC), a field programmable gate array (FPGA), a digital signal processor (DSP), network processor, or the like. The processor 20 may be configured to execute instructions for performing the operations and steps discussed herein.

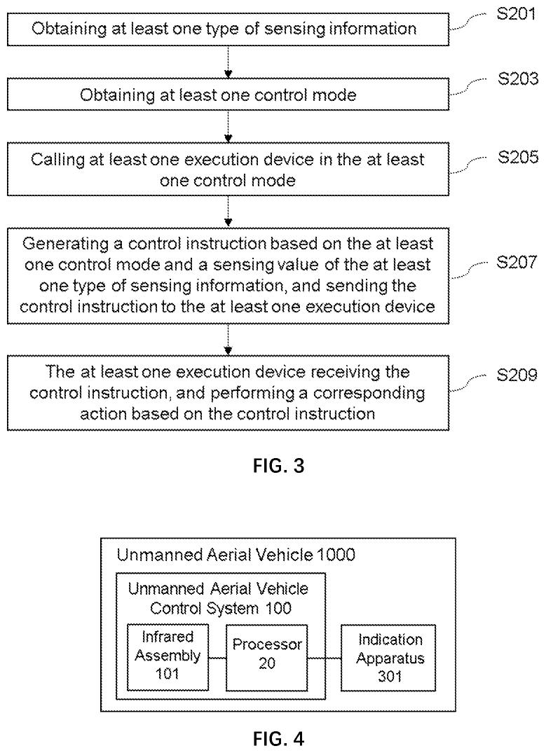

Further, FIG. 3 is a flowchart of an unmanned aerial vehicle control method provided in some exemplary embodiments of the present disclosure. The unmanned aerial vehicle control system 100 may be configured to perform the unmanned aerial vehicle control method shown in FIG. 3. For example, the unmanned aerial vehicle control method provided in some exemplary embodiments of the present disclosure may be applied to the unmanned aerial vehicle control system 100, so that the unmanned aerial vehicle 1000 may implement the unmanned aerial vehicle control method shown in FIG. 3. It may be understood that the unmanned aerial vehicle control method may also be applied to other appropriate unmanned aerial vehicles. In some exemplary embodiments, the unmanned aerial vehicle 1000 may be used as an example for description and is not limited herein.

In some exemplary embodiments, the unmanned aerial vehicle control method may include the following steps.

S201. Obtaining at least one type of sensing information.

In some exemplary embodiments of the present disclosure, an unmanned aerial vehicle 1000 may obtain the at least one type of sensing information by using a sensing assembly 10. Further, the at least one type of sensing information may include status information and/or environment information of the unmanned aerial vehicle 1000. In some exemplary embodiments, the sensing assembly 10 may include at least one sensing assembly 10, a first preset priority setting may be preset for the at least one sensing assembly 10, and the sensing assembly 10 may obtain the at least one type of sensing information based on the first preset priority setting.

Further, in some exemplary embodiments, the sensing assembly 10 may include a sensing apparatus. For example, a sensing apparatus may be disposed in the unmanned aerial vehicle 1000, and the sensing apparatus may be configured to obtain the at least one type of sensing information. For example, in some exemplary embodiments, the status information of the unmanned aerial vehicle 1000 may include at least one of current location information, orientation information, time, acceleration, a speed, a posture, a relative height, a relative distance, power information, and operation resource information; and correspondingly, a sensing apparatus for measuring the status information of the unmanned aerial vehicle 1000 may include at least one of a satellite positioning apparatus, an inertial measurement sensor, a clock, a magnetic field sensor, a pressure sensor, a height sensor, a proximity sensor, a power detection apparatus, and a resource monitor. The environment information of the unmanned aerial vehicle 1000 may include at least one of luminance information, ground texture information, depth information, temperature information, interaction information, wind speed information, air pressure information, and noise information; and correspondingly, a sensing apparatus for measuring the environment information of the unmanned aerial vehicle 1000 may include at least one of a light intensity sensor, an optoelectronic sensor, an infrared sensor, a vision sensor, a temperature sensor, an anemometer, a barometer, and a sound pressure level sensor. It may be understood that the sensing apparatus may be located in any appropriate position of a fuselage 200 of the unmanned aerial vehicle 1000, for example, on a frame, in a frame, on an arm assembly, in an arm assembly, or other appropriate positions. This is not limited herein.

Further, in some exemplary embodiments, the unmanned aerial vehicle 1000 may further include a communication apparatus. The unmanned aerial vehicle 1000 may be communicatively connected to an external device by using the communication apparatus, and may be configured to obtain sensing data by using the external device. Referring to FIG. 2, in some exemplary embodiments, the external device may be a control end 400. For example, the unmanned aerial vehicle 1000 may include the control end 400, and the unmanned aerial vehicle 1000 may be connected to the control end 400 by using the communication apparatus. Further, the communication apparatus disposed in the unmanned aerial vehicle 1000 may be configured to obtain at least one type of sensing information input by the control end 400. For example, in some exemplary embodiments, the sensing information may be input by a user from the control end 400. For example, the user may input the status information of the unmanned aerial vehicle 1000 such as the location information, orientation information, and time from the control end 400, or input the environment information such as the luminance information, temperature information, and interaction information from the control end 400. For example, the control end may be a mobile device and/or a remote control apparatus. Further, the communication apparatus may be connected to the control end 400 in a wireless mode. This is not limited herein.

In some exemplary embodiments, the external device may be a predefined website. For example, the unmanned aerial vehicle 1000 may be connected to the predefined website by using the communication apparatus. In this case, the at least one type of sensing information may be obtained by using the predefined website. For example, the communication apparatus may be connected to the predefined website in a wireless mode. For example, the predefined website may be a meteorological website or an unmanned aerial vehicle air control website, and the unmanned aerial vehicle 1000 may obtain sensing information from the meteorological website or the unmanned aerial vehicle air control website. In some exemplary embodiments, the communication apparatus may be connected to the predefined website in another communication mode, for example, communicatively connected by using a satellite. The predefined website may also include other sensing information that is appropriate for the unmanned aerial vehicle 1000 to obtain. This is not limited herein.

Further, after obtaining the at least one type of sensing information, the sensing assembly 10 may send the sensing information to a processor 20 of an unmanned aerial vehicle control system 100, that is, the processor 20 may obtain the at least one type of sensing information.

S203. Obtaining at least one control mode.

In some exemplary embodiments, the processor 20 of the unmanned aerial vehicle control system 100 may be further configured to obtain the at least one control mode. Further, the at least one control mode may be obtained based on the sensing information obtained in step S201, or may be obtained based on an external instruction. Further, the external instruction may be input by the user, that is, the at least one control mode may be obtained based on the external instruction input by the user. It may be understood that In some exemplary embodiments, the at least one control mode may be further obtained based on a combination of the obtained sensing information and the external instruction input by the user. This is not limited herein.

Further, the at least one control mode may be obtained based on a second preset priority setting. After at least two control modes are obtained, a selection may be made between the at least two control modes based on the second preset priority setting. For example, in some exemplary embodiments, the processor 20 may obtain the at least one control mode based on the sensing information. Further, when the processor 20 obtains at least two control modes based on the sensing information, the processor 20 may make an autonomous selection between the at least two control modes based on the second preset priority setting and may implement an intelligent selection and control on the control mode without requiring an externally input instruction. This may improve user experience.

In some exemplary embodiments, after obtaining the at least two control modes based on the sensing information, the processor 20 may also make a selection between the at least two control modes based on an external instruction. Further, the external instruction may be input by the user by using the control end 400 such as a mobile device and/or a remote controller. In some exemplary embodiments, the control mode may be further determined based on a combination of the obtained control mode and the external instruction input by the user. In this way, the control mode of the unmanned aerial vehicle 1000 may be obtained in a flexible variable configuration mode. This may implement safe intelligent control, and improve user experience.

In some exemplary embodiments, for example, in some exemplary embodiments, the status information of the unmanned aerial vehicle 1000 may include at least the location information, posture information, remaining power information, and operation resource information, the environment information may include at least the luminance information, temperature information, and interaction information, and the control mode may include at least a fill light mode, an obstacle avoidance mode, an alarm mode, an interaction mode, a safety protection mode, and a safe running mode. Further, the processor 20 of the unmanned aerial vehicle control system 100 may make a selection among the fill light mode, the obstacle avoidance mode, the alarm mode, the interaction mode, the safety protection mode, and the safe running mode based on the second preset priority setting. In some exemplary embodiments, the processor 20 of the unmanned aerial vehicle control system 100 may make a selection among the fill light mode, the obstacle avoidance mode, the alarm mode, the interaction mode, the safety protection mode, and the safe running mode based on an external instruction. Further, the external instruction may be input by the user by using the control end 400 such as a mobile device and/or a remote controller.

It may be understood that the foregoing embodiment is only an example for description. The status information and the environment information of the unmanned aerial vehicle 1000 may include other information in addition to the foregoing information, for example, other sensing information related to the unmanned aerial vehicle 1000 such as time information and noise information, and the corresponding control modes may further include other control modes in addition to the foregoing modes. This is not limited herein.

Further, in some exemplary embodiments, after the processor 20 of the unmanned aerial vehicle control system 100 obtains the at least one control mode, a prompt instruction may be generated. As described above, the unmanned aerial vehicle 1000 may include the control end 400. For example, the control end 400 may be a mobile device and/or a remote controller. Further, a display screen 401 may be disposed at the control end, and the prompt instruction is displayed on the display screen 401. In some exemplary embodiments, the prompt instruction is used to display a selected control mode, and the control mode may be autonomously selected by the processor 20, or may be selected based on an external instruction. This is not limited herein.

Further, after at least two control modes are obtained, a prompt instruction may be generated and displayed on the display screen 401, to prompt the user that a selection may be made between the at least two control modes. For example, when two or more control modes conflict, a prompt instruction may be generated and displayed on the display screen 401, to prompt the user to make a selection between the two or more control modes that conflict. In some exemplary embodiments, when the two or more control modes do not conflict, only a prompt instruction may be generated and displayed on the display screen 401. This is not limited herein.

S205. Calling and/or invoking at least one execution device 300 in the at least one control mode.

In some exemplary embodiments, after obtaining the at least one control mode, the processor 20 of the unmanned aerial vehicle control system 100 may call and/or invoke the at least one execution device 300 in the at least one control mode.

Further, the execution device 300 of the unmanned aerial vehicle 1000 may include at least one of an indication apparatus, a fill light apparatus, an illuminating apparatus, a photographing apparatus, a power apparatus, a gimbal posture adjustment apparatus, a projection apparatus, a display apparatus, a signal transfer apparatus, and a power supply apparatus. It may be understood that the execution device 300 of the unmanned aerial vehicle 1000 may further include another appropriate execution device in addition to the foregoing execution device, for example, an execution device such as a spraying apparatus or a surveying and mapping apparatus. This is not limited herein. In subsequent embodiments, the embodiments of the present disclosure will be further described with reference to several specific execution devices 300. It may be understood that the embodiments of the present disclosure are all exemplary examples and are not limited herein.

S207. Generating a control instruction based on the at least one control mode and a sensing value of the at least one type of sensing information, and sending the control instruction to the at least one execution device 300.

In some exemplary embodiments, the processor 20 of the unmanned aerial vehicle control system 100 of the unmanned aerial vehicle 1000 may generate the control instruction based on the at least one control mode and the sensing value of the at least one type of sensing information, and may send the control instruction to the at least one execution device 300.

S209. The at least one execution device 300 receiving the control instruction, and performing a corresponding action based on the control instruction.

In some exemplary embodiments, a third preset priority setting may be preset for the at least one execution device 300. For example, the at least one execution device 300 may receive the control instruction based on the third preset priority setting, and perform the corresponding action based on the control instruction. In other exemplary embodiments, alternatively, the at least one execution device 300 may first receive the control instruction, and then perform the corresponding action based on the third preset priority setting and the control instruction. This is not limited herein.

The following further describes the embodiments of the present disclosure with reference to an exemplary sensing assembly 10 and an exemplary execution device 300. It may be understood that, under a condition that no conflict occurs, the following embodiments and features in the embodiments may be mutually combined.

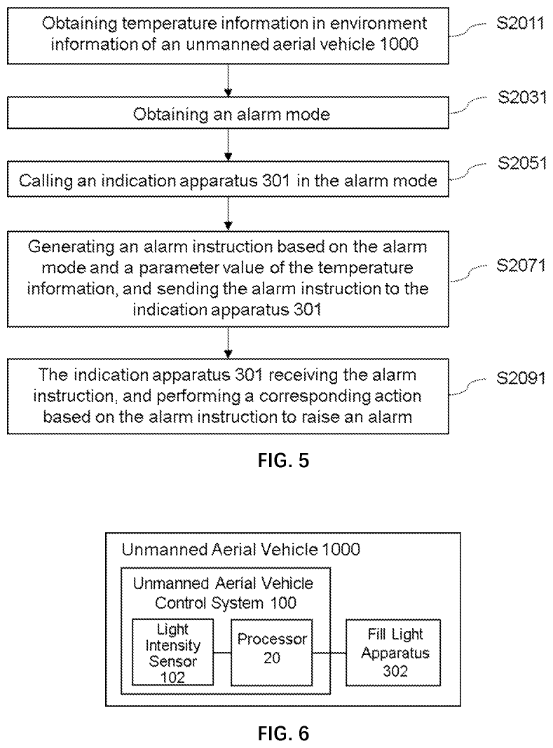

Referring to FIG. 4, in some exemplary embodiments, a sensing assembly 10 of an unmanned aerial vehicle 1000 may be an infrared sensor 101 configured to detect temperature information in environment information of the unmanned aerial vehicle 1000, and an execution device 300 may be an indication apparatus 301. In some exemplary embodiments, referring to FIG. 5, an unmanned aerial vehicle control method in some exemplary embodiments of the present disclosure may include the following steps.

S2011. Obtaining temperature information in environment information of an unmanned aerial vehicle 1000.

In some exemplary embodiments, a sensing assembly 10 may be an infrared sensor 101, and the infrared sensor 101 may be configured to detect the temperature information in the environment information of the unmanned aerial vehicle 1000. It may be understood that these embodiments are only examples for description. In some exemplary embodiments, the temperature information in the environment information of the unmanned aerial vehicle 1000 may also be obtained by using another appropriate temperature sensing apparatus. This is not limited herein.

S2031. Obtaining an alarm mode.

Further, the unmanned aerial vehicle 1000 may obtain the alarm mode. In some exemplary embodiments, the unmanned aerial vehicle 1000 may automatically obtain the alarm mode based on the temperature information. For example, when a heat sensing value obtained by the infrared sensor 101 is greater than a preset heat threshold, the heat sensing value may be sent to the sensing assembly 10 of an unmanned aerial vehicle control system 100. The sensing assembly 10 may send the heat sensing value to a processor 20, and the processor 20 may obtain the alarm mode. In some exemplary embodiments, the unmanned aerial vehicle 1000 may also obtain the alarm mode based on an external instruction input by a user. For example, the user may directly input a heat sensing value greater than the preset heat threshold to obtain the alarm mode, or may directly obtain the alarm mode by inputting. This is not limited herein.

S2051. Calling and/or invoking an indication apparatus 301 in the alarm mode.

After obtaining the alarm mode, the unmanned aerial vehicle 1000 may call and/or invoke the indication apparatus 301 in an execution device 300 in the alarm mode. Further, in some exemplary embodiments, the indication apparatus 301 may include at least one of a laser generation apparatus, an indicator, and an alarm device. It may be understood that the indication apparatus 301 may further include another appropriate apparatus for indicating an alarm. This is not limited herein.

S2071. Generating an alarm instruction based on the alarm mode and a parameter value of the temperature information, and sending the alarm instruction to the indication apparatus 301.

In some exemplary embodiments, in some exemplary embodiments, when the heat sensing value obtained by the infrared sensor 101 is greater than the preset heat threshold, the heat sensing value may be sent to the processor 20 of the unmanned aerial vehicle control system 100, and the processor 20 may calculate a difference between the heat sensing value and the preset heat threshold, and determine whether the heat sensing value is abnormal. For example, the user may predefine a heat sensing value in a normal range and a heat sensing value when a fire breaks out. When the heat sensing value obtained by the infrared sensor 101 exceeds the heat sensing value in the normal range, it may be determined that the heat sensing value is abnormal.

In some exemplary embodiments, the user may further predefine a heat sensing value of the sun that is obtained by the infrared sensor of the unmanned aerial vehicle 1000, to avoid sending an incorrect determining instruction after the infrared sensor obtains the heat sensing value of the sun.

Further, when determining that the heat sensing value is abnormal, the processor 20 may generate an alarm instruction and send the alarm instruction to the indication apparatus 301 in the execution device 300.

S2091. The indication apparatus 301 receiving the alarm instruction, and performing a corresponding action based on the alarm instruction to raise an alarm.

In some exemplary embodiments, in some exemplary embodiments, when the indication apparatus 301 is an indicator and an alarm device, the unmanned aerial vehicle 1000 may turn on the indicator and the alarm device, where the indicator may flash and the alarm device may raise an alarm, to warn that the heat sensing value is abnormal.

In some exemplary embodiments, when the indication apparatus 301 is a laser generation apparatus, an indicator, and an alarm device, the unmanned aerial vehicle 1000 may first determine information about a position whose heat sensing value is abnormal, for example, determine, based on a relative distance or a relative height between the unmanned aerial vehicle 1000 and the position whose heat sensing value is abnormal, the information about the position whose heat sensing value is abnormal, and may send the information about the position to the processor 20. The processor 20 may generate a laser generation instruction and send the laser generation instruction to the laser generation apparatus, to adjust a beam direction emitted by the laser generation apparatus to point to the position whose heat sensing value is abnormal, and may turn on the indicator and the alarm device, where the indicator flashes and the alarm device raises an alarm, to warn that the heat sensing value in the position is abnormal. In this way, the unmanned aerial vehicle 1000 can automatically enter the alarm mode based on the temperature information in the environment information, for example, implement an intelligent alarm when the heat sensing value is abnormal, to find a fire point in time in field monitoring and raise an alarm.

It may be understood that In some exemplary embodiments, the unmanned aerial vehicle 1000 may further distinguish a heat sensing value range of a human body within a normal range, so that the unmanned aerial vehicle 1000 is applied to a scenario such as policing, field search and rescue, or rescue. This is not limited herein.

In the foregoing embodiment, the laser generation apparatus, the indicator, and the alarm device in the indication apparatus 301 in the execution device 300 may perform a corresponding action based on the third preset priority setting. For example, in some exemplary embodiments, the third preset priority setting may be set as “laser generation apparatus >indicator >alarm device”, or may be set as “indicator >alarm device >laser generation apparatus”, or a same priority may be set for the alarm device and the indicator, that is, the alarm device and the indicator respond simultaneously. It may be understood that these embodiments are only examples for description, and is not limited herein.

Further, in some exemplary embodiments, the unmanned aerial vehicle 1000 may further include a control end 400, and a display screen 401 may be disposed at the control end 400. In some exemplary embodiments, after the alarm mode is obtained, a prompt instruction may be generated on the display screen 401, to prompt the user that the unmanned aerial vehicle 1000 enters the alarm mode. In some exemplary embodiments, the unmanned aerial vehicle 1000 may display a sensed infrared image on the display screen 401 in real time, to facilitate operations such as observation. This is not limited herein in some exemplary embodiments.

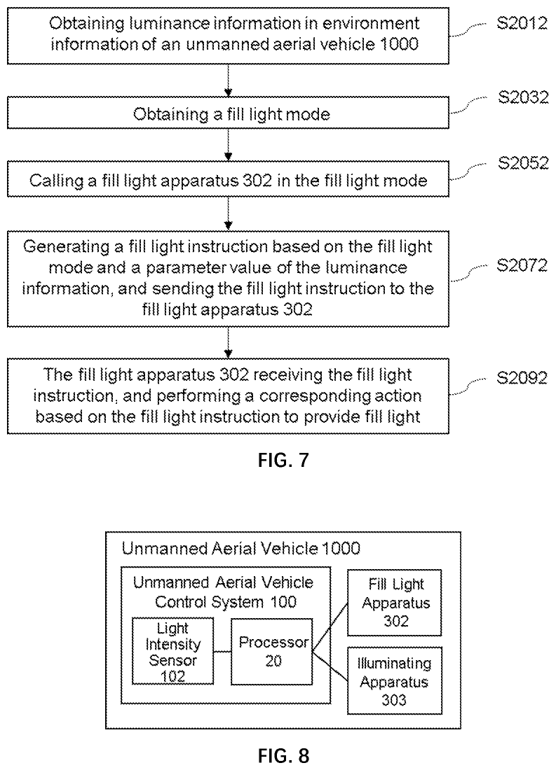

Referring to FIG. 6, in some exemplary embodiments, a sensing assembly 10 of an unmanned aerial vehicle 1000 is a light intensity sensor 102, where the light intensity sensor 102 may be configured to obtain luminance information in environment information of the unmanned aerial vehicle 1000, and an execution device 300 of the unmanned aerial vehicle 1000 may be a fill light apparatus 302. In some exemplary embodiments, referring to FIG. 7, an unmanned aerial vehicle control method in some exemplary embodiments of the present disclosure may include the following steps.

S2012. Obtaining luminance information in environment information of an unmanned aerial vehicle 1000.

In some exemplary embodiments, a sensing assembly 10 may be a light intensity sensor 102, and the light intensity sensor may be configured to obtain the luminance information in the environment information of the unmanned aerial vehicle 1000. It may be understood that these embodiments are only examples for description. In some exemplary embodiments, the luminance information in the environment information of the unmanned aerial vehicle 1000 may also be obtained by using another appropriate light intensity sensing apparatus. This is not limited herein.

S2032. Obtaining a fill light mode.

Further, the unmanned aerial vehicle 1000 may obtain the fill light mode. In some exemplary embodiments, the unmanned aerial vehicle 1000 may automatically obtain the fill light mode based on the luminance information, for example, when a light intensity sensing value obtained by the light intensity sensor 102 is less than a preset light intensity threshold, send the light intensity sensing value to the sensing assembly 10 of an unmanned aerial vehicle control system 100. The sensing assembly 10 may send the light intensity sensing value to a processor 20, and the processor 20 may obtain the fill light mode. In some exemplary embodiments, the unmanned aerial vehicle 1000 may also obtain the fill light mode based on an external instruction input by a user. For example, the user may directly input a light intensity sensing value less than the preset light intensity threshold to enter the fill light mode, or may directly obtain the fill light mode. This is not limited herein.

S2052. Calling and/or invoking a fill light apparatus 302 in the fill light mode.

After obtaining the fill light mode, the unmanned aerial vehicle 1000 may call and/or invoke the fill light apparatus 302 in an execution device 300 in the fill light mode. In some exemplary embodiments, the fill light apparatus may be a visible light compensation apparatus, or may be an invisible light compensation apparatus, for example, an infrared light compensation apparatus. This is not limited herein.

S2072. Generating a fill light instruction based on the fill light mode and a parameter value of the luminance information, and sending the fill light instruction to the fill light apparatus 302.

In some exemplary embodiments, in some exemplary embodiments, when the light intensity sensing value obtained by the light intensity sensor 102 is less than the preset light intensity threshold, the light intensity sensing value may be sent to the processor 20 of the unmanned aerial vehicle control system 100. The processor 20 may calculate a difference between the light intensity sensing value and the preset light intensity threshold, may obtain a light intensity compensation value through calculation based on the difference between the light intensity sensing value and the preset light intensity threshold, and generate a fill light instruction based on the light intensity compensation value. The fill light instruction may be sent to the fill light apparatus 302 in the execution device 300. In some exemplary embodiments, the fill light apparatus 302 may be, for example, a fill light lamp.

S2092. The fill light apparatus 302 receiving the fill light instruction, and performing a corresponding action based on the fill light instruction to provide fill light.

In some exemplary embodiments, in some exemplary embodiments, after receiving the fill light instruction, the fill light apparatus 302 performs the corresponding action based on the fill light instruction, that is, the fill light apparatus 302 emits expected light to adjust light intensity and compensate for the light intensity compensation value. In this way, the unmanned aerial vehicle 1000 may intelligently provide fill light in the fill light mode, for example, provide fill light in an environment with low light intensity.

It may be understood that in some exemplary embodiments, the unmanned aerial vehicle 1000 may also obtain the luminance information in the environment information in a photographing mode, that is, automatically obtain the fill light mode in the photographing mode, to achieve a better imaging effect in an application scenario of photographing or video recording. For example, the unmanned aerial vehicle 1000 may determine, based on automatic exposure time or an automatic exposure gain of an imaging system of a photographing apparatus, whether it is necessary to enter the fill light mode, and may obtain a light intensity compensation value through calculation based on the automatic exposure time and the automatic exposure gain. In some exemplary embodiments, when the automatic exposure time becomes longer and the automatic exposure gain increases, it is determined that the fill light mode needs to be obtained, and a light intensity compensation value may be obtained through calculation based on the automatic exposure time and the automatic exposure gain. Further, automatic exposure time and an automatic exposure gain during next photographing are obtained, until the compensated light intensity reaches an appropriate value. It may be understood that these embodiments are only examples for description, and is not limited herein.

Referring to FIG. 8, In some exemplary embodiments, the execution device 300 of the unmanned aerial vehicle 1000 may further include a fill light apparatus 302 and an illuminating apparatus 303. Correspondingly, the unmanned aerial vehicle 1000 may automatically obtain the fill light mode and/or an illuminating mode based on the luminance information. Further, the unmanned aerial vehicle 1000 may call and/or invoke the illuminating apparatus 303 in the execution device 300 in the illuminating mode.

In some exemplary embodiments, the unmanned aerial vehicle 1000 may obtain a control mode based on a second preset priority setting. For example, after obtaining the luminance information, the unmanned aerial vehicle 1000 may determine, based on the second preset priority setting, a sequence of obtaining control modes. For example, in some exemplary embodiments, the second preset priority setting of the unmanned aerial vehicle 1000 may be set as “fill light mode>illuminating mode”. For example, when the light intensity sensing value obtained by the unmanned aerial vehicle 1000 is less than the preset light intensity threshold, the unmanned aerial vehicle 1000 may first enter the fill light mode, and then determine whether it is necessary to enter the illuminating mode. In some exemplary embodiments, the second preset priority setting of the unmanned aerial vehicle 1000 may also be set as “illuminating mode>fill light mode”. In this case, when the light intensity sensing value obtained by the unmanned aerial vehicle 1000 is less than the preset light intensity threshold, the unmanned aerial vehicle 1000 may first enter the illuminating mode, and then determine whether it is necessary to enter the fill light mode. This is not limited herein.

It may be understood that the fill light apparatus 302 and the illuminating apparatus 303 may be a same apparatus, or may be different apparatuses. For example, when the fill light apparatus 302 is a visible light compensation apparatus, the illuminating apparatus 303 and the fill light apparatus 302 may be a same visible light compensation apparatus. In some exemplary embodiments, the illuminating apparatus 303 and the fill light apparatus 302 may also be disposed as different apparatuses. This is not limited herein.

Further, in some exemplary embodiments, the unmanned aerial vehicle 1000 may further include a control end 400, and a display screen 401 may be disposed at the control end 400. In some exemplary embodiments, after the fill light mode and/or the illuminating mode are/is obtained, a prompt instruction may be generated on the display screen 401, to prompt the user that the unmanned aerial vehicle 1000 enters the fill light mode and/or the illuminating mode. Further, when two or more control modes conflict, a prompt instruction may be generated and displayed on the display screen 401 to prompt the user. For example, when the fill light mode and the illuminating mode conflict, the unmanned aerial vehicle 1000 may generate a prompt instruction, to prompt the user to select an appropriate control mode by inputting an instruction.

In some exemplary embodiments, the display screen 401 may further display the light intensity sensing value, the light intensity compensation value, or the like, to facilitate observation, operations, or the like by the user, and improve user experience.

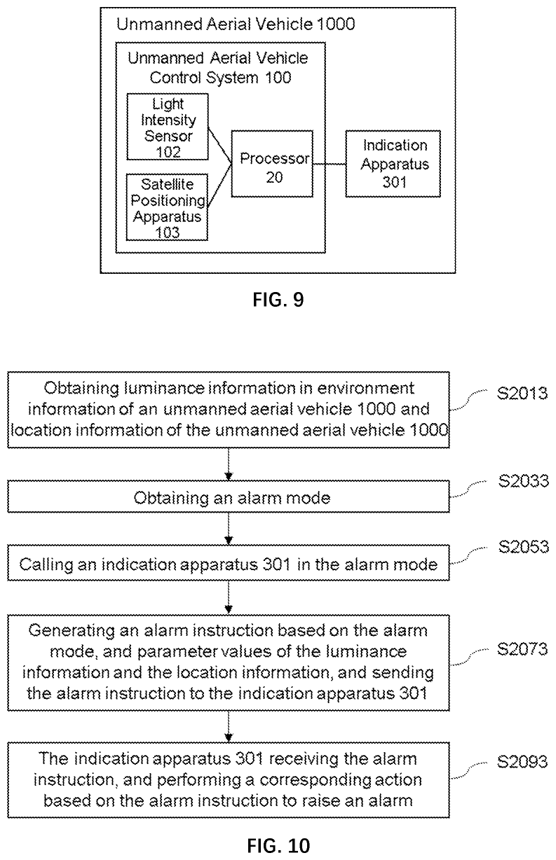

Referring to FIG. 9, in some exemplary embodiments, a sensing assembly 10 of an unmanned aerial vehicle 1000 is a light intensity sensor 102 and a satellite positioning apparatus 103, where the light intensity sensor 102 may be configured to obtain luminance information in environment information of the unmanned aerial vehicle 1000, and the satellite positioning apparatus 103 may be configured to obtain location information of the unmanned aerial vehicle 1000. Further, an execution device 300 of the unmanned aerial vehicle 1000 is an indication apparatus 301. In some exemplary embodiments, referring to FIG. 10, an unmanned aerial vehicle control method in some exemplary embodiments of the present disclosure may include the following steps.

S2013. Obtaining luminance information in environment information of an unmanned aerial vehicle 1000 and location information of the unmanned aerial vehicle 1000.

In some exemplary embodiments, a sensing assembly 10 is a light intensity sensor 102 and a satellite positioning apparatus 103, where the light intensity sensor 102 may be configured to obtain the luminance information in the environment information of the unmanned aerial vehicle 1000, and the satellite positioning apparatus 103 may be configured to obtain the location information of the unmanned aerial vehicle 1000. It may be understood that these embodiments are only examples for description. In some exemplary embodiments, the location information of the unmanned aerial vehicle 1000 or the luminance information in the environment information may also be obtained by using another appropriate sensing apparatus. This is not limited herein.

S2033. Obtaining an alarm mode.

Further, the unmanned aerial vehicle 1000 may obtain the alarm mode. For example, in some exemplary embodiments, the unmanned aerial vehicle 1000 may automatically obtain the alarm mode based on the luminance information and the location information. In some exemplary embodiments, the unmanned aerial vehicle 1000 may obtain the alarm mode based on an external instruction input by a user. For example, the user may obtain the alarm mode by inputting light intensity information less than a preset luminance threshold and distance information greater than a preset distance threshold, or may directly obtain the alarm mode. This is not limited herein.

S2053. Calling and/or invoking an indication apparatus 301 in the alarm mode.

After obtaining the alarm mode, the unmanned aerial vehicle 1000 may call and/or invoke the indication apparatus 301 in an execution device 300 in the alarm mode. Further, in some exemplary embodiments, the indication apparatus 301 may include at least one of an indicator and an alarm device. This is not limited herein.

S2073. Generating an alarm instruction based on the alarm mode, and parameter values of the luminance information and the location information, and sending the alarm instruction to the indication apparatus 301.

In some exemplary embodiments, in some exemplary embodiments, when a light intensity sensing value obtained by the light intensity sensor 102 is less than a preset threshold, the light intensity sensing value may be sent to a processor 20 of an unmanned aerial vehicle control system 100. The processor 20 may calculate a difference between the light intensity sensing value and the preset light intensity threshold, and determine, based on the difference between the light intensity sensing value and the preset light intensity threshold, whether it is in a situation with weak light.

Further, when the unmanned aerial vehicle 1000 is in the situation with weak light, the satellite positioning apparatus 103 in the sensing assembly 10 may obtain the location information of the unmanned aerial vehicle 1000 by sensing, and may send the location information to the processor 20 of the unmanned aerial vehicle control system 100. The processor 20 may calculate a distance between a location of the unmanned aerial vehicle 1000 and an operator based on the location information. When the distance is greater than the preset distance threshold, the processor 20 may control the unmanned aerial vehicle 1000 to enter the alarm mode, and generate an alarm instruction based on the luminance information and the location information. The alarm instruction may be sent to the indication apparatus in the execution device 300.

S2093. The indication apparatus 301 receiving the alarm instruction, and performing a corresponding action based on the alarm instruction to raise an alarm.

In some exemplary embodiments, in some exemplary embodiments, after receiving the alarm instruction, the indication apparatus 301 may turn on the indicator and the alarm device based on the alarm instruction, where the indicator may flash and the alarm device may raise an alarm, to warn that the unmanned aerial vehicle 1000 is in a position beyond a line of sight under weak light. In this way, the unmanned aerial vehicle 1000 may automatically enter the alarm mode based on the luminance information in the environment information and the location information. For example, when the unmanned aerial vehicle 1000 is beyond the line of sight at night, the indicator may flash at a preset frequency, and the alarm device may raise an alarm, to facilitate discovery of the unmanned aerial vehicle 1000.

Further, in some exemplary embodiments, the unmanned aerial vehicle 1000 may further include a control end 400, and a display screen 401 may be disposed at the control end 400. In some exemplary embodiments, after the alarm mode is obtained, a prompt instruction may be generated on the display screen 401, to prompt the user that the unmanned aerial vehicle 1000 is beyond the line of sight under weak light. Further, the display screen 401 may further display real-time location information of the unmanned aerial vehicle 1000. This is not limited herein.

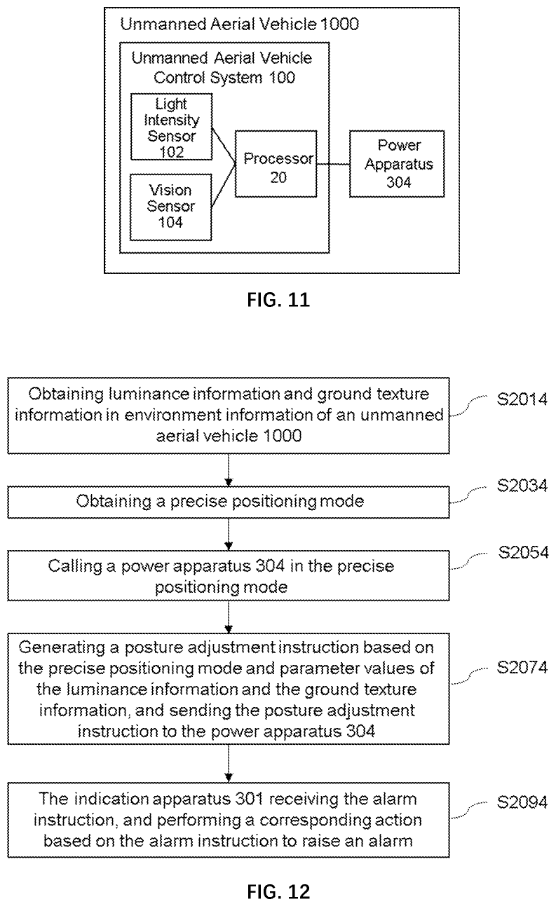

Referring to FIG. 11, in some exemplary embodiments, a sensing assembly 10 of an unmanned aerial vehicle 1000 is a light intensity sensor 102 and a vision sensor 104, where the light intensity sensor 102 may be configured to obtain luminance information in environment information of the unmanned aerial vehicle 1000, and the vision sensor may be mounted below the unmanned aerial vehicle 1000, and configured to sense ground texture information. Further, an execution device 300 of the unmanned aerial vehicle 1000 may be a power apparatus 304. In some exemplary embodiments, referring to FIG. 12, an unmanned aerial vehicle control method in some exemplary embodiments of the present disclosure may include the following steps.

S2014. Obtaining luminance information and ground texture information in environment information of an unmanned aerial vehicle 1000.

In some exemplary embodiments, a sensing assembly 10 may be a light intensity sensor 102 and a vision sensor 104, where the light intensity sensor 102 may be configured to sense the luminance information in the environment information of the unmanned aerial vehicle 1000, and the vision sensor 104 may be mounted below the unmanned aerial vehicle 1000, and configured to sense the ground texture information. Further, the vision sensor 104 may be, for example, a visible light sensor or an infrared sensor, and the corresponding texture information may be, for example, visible light or infrared texture information.

It may be understood that these embodiments are only examples for description. In some exemplary embodiments, the luminance information and the ground texture information in the environment information of the unmanned aerial vehicle 1000 may also be obtained by using another appropriate sensing apparatus. This is not limited herein.

S2034. Obtaining a precise positioning mode.

Further, the unmanned aerial vehicle 1000 may obtain the precise positioning mode. For example, in some exemplary embodiments, the unmanned aerial vehicle 1000 may automatically obtain the precise positioning mode based on the luminance information and the texture information. In some exemplary embodiments, the unmanned aerial vehicle 1000 may obtain the precise positioning mode based on an external instruction input by a user. For example, the user may obtain the precise positioning mode by inputting a light intensity sensing value less than a preset light intensity threshold, or may directly obtain the precise positioning mode by inputting. This is not limited herein.

S2054. Calling and/or invoking a power apparatus 304 in the precise positioning mode.

After obtaining the precise positioning mode, the unmanned aerial vehicle 1000 may call and/or invoke the power apparatus 304 in an execution device 300 in the precise positioning mode. For example, in some exemplary embodiments, the power apparatus 304 may include a motor assembly and a propeller assembly that are disposed on an arm assembly, where a posture or an azimuth of the unmanned aerial vehicle 1000 may be adjusted by using the motor assembly and the propeller assembly that are disposed on the arm assembly, to achieve expected moving of the unmanned aerial vehicle 1000. For example, when the unmanned aerial vehicle 1000 is a four-rotor aircraft, the arm assembly of the unmanned aerial vehicle 1000 may include four arms, and the corresponding power apparatus 304 may include four motor assemblies and four propeller assemblies, which are respectively disposed on the arms. Further, the posture or the azimuth of the unmanned aerial vehicle 1000 may be adjusted by using the motor assembly and the propeller assembly that are disposed on the arm assembly, to achieve expected moving of the unmanned aerial vehicle 1000. In some exemplary embodiments, the unmanned aerial vehicle 1000 may also include another appropriate power apparatus 304. This is not limited herein.

S2074. Generating a posture adjustment instruction based on the precise positioning mode and parameter values of the luminance information and the ground texture information, and sending the posture adjustment instruction to the power apparatus 304.

In some exemplary embodiments, in some exemplary embodiments, when a light intensity sensing value obtained by the light intensity sensor 102 is less than the preset light intensity threshold, the light intensity sensing value may be sent to a processor 20 of an unmanned aerial vehicle control system 100. The processor 20 may calculate a difference between the light intensity sensing value and the preset light intensity threshold, and determine, based on the difference between the light intensity sensing value and the preset light intensity threshold, whether it is in a situation with weak light.

Further, when the unmanned aerial vehicle 1000 is in the situation with weak light, the vision sensor 104 in the sensing assembly 10 may obtain the ground texture information by sensing, and may send the ground texture information to the processor 20 of the unmanned aerial vehicle control system 100. In the precise positioning mode, the processor 20 may generate a motion instruction after performing image processing based on the ground texture information, and send the motion instruction to the power apparatus 304 in the execution device 300.

S2094. The power apparatus 304 receiving the posture adjustment instruction, and performing a corresponding action based on the posture adjustment instruction to implement precise positioning.

In some exemplary embodiments, in some exemplary embodiments, after receiving the motion instruction, the power apparatus 304 performs the corresponding action based on the motion instruction. For example, the power apparatus 304 may be controlled to make motion compensation, to implement precise positioning under weak light. For example, the motion instruction may be a small-range motion instruction, and the power apparatus 304 makes small-range motion compensation under control of the small-range motion instruction. In this way, the unmanned aerial vehicle 1000 can implement precise positioning in a situation with weak light, for example, at night.

Further, in some exemplary embodiments, the unmanned aerial vehicle 1000 may obtain at least one type of sensing information based on a first preset priority setting. For example, when the sensing assembly 10 includes the plurality of sensing apparatuses listed in previous embodiments, the sensing assembly 10 may first obtain the luminance information based on the first preset priority setting, then obtain positioning information of the unmanned aerial vehicle 1000, and finally obtain the ground texture information. In some exemplary embodiments, the unmanned aerial vehicle 1000 may obtain a fill light mode and/or an illuminating mode based on the luminance information that is first obtained; then obtain an alarm mode with reference to the obtained luminance information and positioning information; and finally obtain the precise positioning mode with reference to the obtained luminance information and ground texture information. In other words, in some exemplary embodiments, the unmanned aerial vehicle 1000 may obtain, based on the first preset priority setting for obtaining sensing information, a control mode corresponding to the sensing information.

In some exemplary embodiments, the unmanned aerial vehicle 1000 may obtain a control mode based on a second preset priority setting. For example, after obtaining the sensing information, the unmanned aerial vehicle 1000 may determine, based on the second preset priority setting, a sequence of obtaining control modes. In some exemplary embodiments, still with respect to the sensing assembly 10 including the plurality of sensing apparatuses listed in previous embodiments, after obtaining the luminance information, the positioning information, and the ground texture information, the unmanned aerial vehicle 1000 may obtain at least one of the control modes based on the second preset priority setting. For example, when the processor 20 of the unmanned aerial vehicle control system 100 determines that the environment information of the unmanned aerial vehicle 1000 is a situation with weak light, the unmanned aerial vehicle 1000 may enter at least two control modes. For example, the unmanned aerial vehicle 1000 may enter the fill light mode and/or the alarm mode and/or the precise positioning mode. In some exemplary embodiments, the second preset priority setting of the unmanned aerial vehicle 1000 may be set as “alarm mode >precise positioning mode >fill light mode”.

In some exemplary embodiments, in some exemplary embodiments, for the control mode, the unmanned aerial vehicle 1000 may first determine, based on the second preset priority setting, whether a condition for obtaining the alarm mode is satisfied, then determine whether a condition for obtaining the precise positioning mode is satisfied, and finally determine whether a condition for obtaining the fill light mode is satisfied. For example, when the unmanned aerial vehicle 1000 satisfies the condition for the alarm mode, that is, satisfies that the unmanned aerial vehicle 1000 is beyond the line of sight under weak light in one or more of the previous embodiments, an indication apparatus 301 in the execution device 300 of the unmanned aerial vehicle 1000 may raise an alarm; when the unmanned aerial vehicle 1000 does not satisfy the condition for the alarm mode, the unmanned aerial vehicle 1000 may determine whether the unmanned aerial vehicle 1000 satisfies the condition for the precise positioning mode; and when the condition for the precise positioning mode under weak light is satisfied, the power apparatus 304 in the execution device 300 of the unmanned aerial vehicle 1000 may adjust the unmanned aerial vehicle 1000 to make motion compensation, to implement precise positioning. Further, after completing precise positioning under weak light, the unmanned aerial vehicle 1000 may determine whether it is necessary to enter the fill light mode. For example, after entering a photographing mode, the unmanned aerial vehicle 1000 may automatically obtain the fill light mode, to achieve a better imaging effect under weak light.

It may be understood that after obtaining the precise positioning mode, the unmanned aerial vehicle 1000 may automatically enter or not enter the fill light mode, or select to enter or not to enter the fill light mode based on an external instruction input by the user. This is not limited herein. Further, the unmanned aerial vehicle 1000 may obtain a corresponding control mode based on the sensing information, or may obtain a corresponding mode based on an external instruction input by the user, or may further obtain a corresponding control mode based on a combination of the sensing information and an instruction input by the user. This is not limited herein.

Further, in some exemplary embodiments, the unmanned aerial vehicle 1000 may further include a control end 400, and a display screen 401 may be disposed at the control end 400. In some exemplary embodiments, after a corresponding control mode, for example, the precise positioning mode, is obtained, a prompt instruction may be generated on the display screen 401, to prompt the user that the unmanned aerial vehicle 1000 enters the obtained precise positioning mode.

Further, in some exemplary embodiments, when two or more control modes conflict, a prompt instruction may be generated and displayed on the display screen 401 to prompt the user. For example, when the fill light mode and the precise positioning mode conflict, the unmanned aerial vehicle 1000 may generate a prompt instruction and displays the prompt instruction on the display screen 401, to prompt the user to select an appropriate control mode by inputting an instruction.

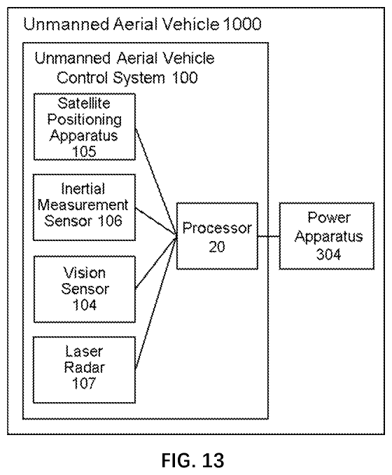

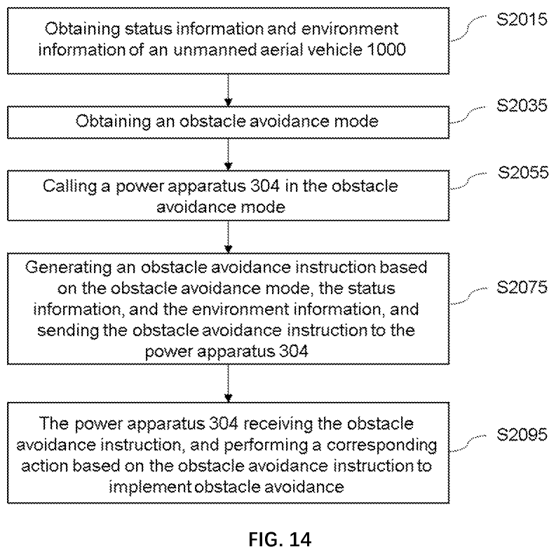

In some exemplary embodiments, a sensing assembly 10 of an unmanned aerial vehicle 1000 may include different sensing apparatuses, to obtain a plurality of types of sensing information. Further, the unmanned aerial vehicle 1000 may obtain the plurality of the sensing information based on a first preset priority setting. Referring to FIG. 13, the sensing assembly 10 of the unmanned aerial vehicle 1000 may include a satellite positioning apparatus 105, an inertial measurement sensor 106, a vision sensor 104, and a laser radar 107. Further, an execution device 300 of the unmanned aerial vehicle 1000 is a power apparatus 304. In some exemplary embodiments, referring to FIG. 14, an unmanned aerial vehicle control method in some exemplary embodiments of the present disclosure may include the following steps.

S2015. Obtaining status information and environment information of an unmanned aerial vehicle 1000.

In some exemplary embodiments, in some exemplary embodiments, the unmanned aerial vehicle 1000 may first obtain the status information of the unmanned aerial vehicle 1000, and then obtain the environment information of the unmanned aerial vehicle 1000. Further, the status information of the unmanned aerial vehicle 1000 may include location information and posture information, and the environment information may include depth information. In some exemplary embodiments, a priority of the location information may be preset to be higher than that of the posture information. For example, in some exemplary embodiments, a first preset priority setting of the sensing information may be set as “location information >posture information >depth information”.

In some exemplary embodiments, in some exemplary embodiments, a sensing assembly 10 of the unmanned aerial vehicle 1000 may include a satellite positioning apparatus 105, an inertial measurement sensor 106, a vision sensor 104, and a laser radar 107. The sensing assembly 10 may first obtain the location information of the unmanned aerial vehicle 1000 by using the satellite positioning apparatus 105, then obtain the posture information of the unmanned aerial vehicle 1000 by using the inertial measurement sensor 106, and finally obtain the depth information in the environment information of the unmanned aerial vehicle 1000 by using the vision sensor 104 and/or the laser radar 107.

It may be understood that these embodiments are only examples for description. The unmanned aerial vehicle 1000 may also include another sensing assembly 10 for obtaining the status information and the environment information of the unmanned aerial vehicle, and the first preset priority setting of the sensing information may be set in any appropriate sequence. This is not limited herein.

S2035. Obtaining an obstacle avoidance mode.

Further, the unmanned aerial vehicle 1000 may obtain the obstacle avoidance mode. For example, in some exemplary embodiments, the unmanned aerial vehicle 1000 may obtain the obstacle avoidance mode based on the status information and the environment information of the unmanned aerial vehicle 1000 that are obtained by the sensing assembly 10. In some exemplary embodiments, the unmanned aerial vehicle 1000 may also obtain the obstacle avoidance mode based on an external instruction input by a user. For example, the user may directly obtain the obstacle avoidance mode by inputting. This is not limited herein.

S2055. Calling and/or invoking a power apparatus 304 in the obstacle avoidance mode.

After obtaining the obstacle avoidance mode, the unmanned aerial vehicle 1000 may call and/or invoke the power apparatus 304 in an execution device 300 in the obstacle avoidance mode, to implement an obstacle avoidance function. In some exemplary embodiments, the power apparatus 304 may include a motor assembly and a propeller assembly. As described above, the motor assembly and the propeller assembly may be disposed on an arm assembly. For example, when the unmanned aerial vehicle 1000 is a four-rotor aircraft, the arm assembly of the unmanned aerial vehicle 1000 may include four arms, and the corresponding power apparatus 304 may include four motor assemblies and four propeller assemblies, which are respectively disposed on the arms. Further, the posture or the azimuth of the unmanned aerial vehicle 1000 may be adjusted by using the motor assembly and the propeller assembly that are disposed on the arm assembly, to achieve expected moving of the unmanned aerial vehicle 1000. In some exemplary embodiments, the unmanned aerial vehicle 1000 may also include another appropriate power apparatus 304. This is not limited herein.

S2075. Generating an obstacle avoidance instruction based on the obstacle avoidance mode, the status information, and the environment information, and sending the obstacle avoidance instruction to the power apparatus 304.

In some exemplary embodiments, in some exemplary embodiments, after obtaining the status information and the environment information, the sensing assembly 10 of the unmanned aerial vehicle 1000 may send the information to a processor 20 of an unmanned aerial vehicle control system 100. In the obstacle avoidance mode, the processor 20 may generate the obstacle avoidance instruction based on the status information and the environment information, and send the obstacle avoidance instruction to the power apparatus 304 in the execution device 300.

S2095. The power apparatus 304 receiving the obstacle avoidance instruction, and performing a corresponding action based on the obstacle avoidance instruction to implement obstacle avoidance.

In some exemplary embodiments, in some exemplary embodiments, the power apparatus 304 may receive the obstacle avoidance instruction, and perform the corresponding action, for example, control the unmanned aerial vehicle 1000 to fly toward a direction away from an obstacle, or fly around the obstacle, or hover in a current position or perform small-range motion adjustment in a current position.

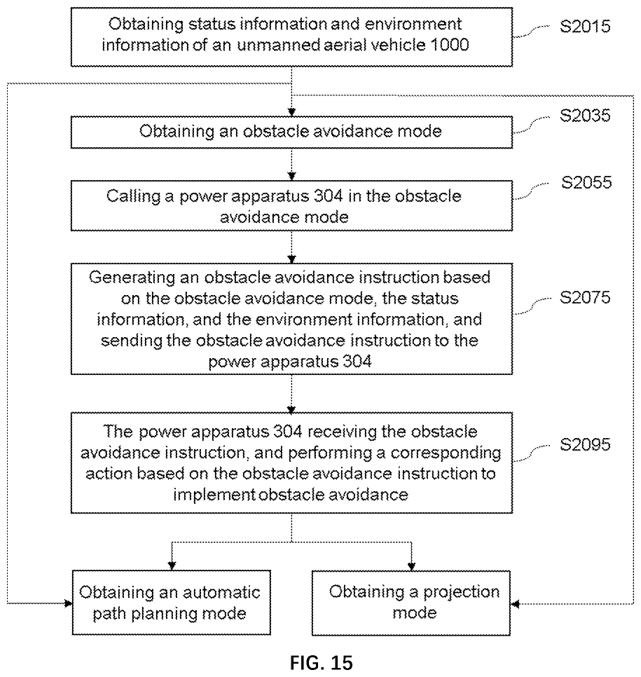

Further, referring to FIG. 15, after recognizing the obstacle in the obstacle avoidance mode, the unmanned aerial vehicle 1000 may further enter an automatic path planning mode, implement automatic planning of a flight path to keep away from the obstacle, ensure that the unmanned aerial vehicle 1000 automatically avoids the obstacle during flight, and implement safe reliable flight. It may be understood that these embodiments are only examples for description. In some exemplary embodiments, the unmanned aerial vehicle 1000 may not recognize the obstacle, but directly enters the automatic path planning mode based on the status information and the environment information of the unmanned aerial vehicle 1000, to facilitate automatic planning of the flight path. This is not limited herein.

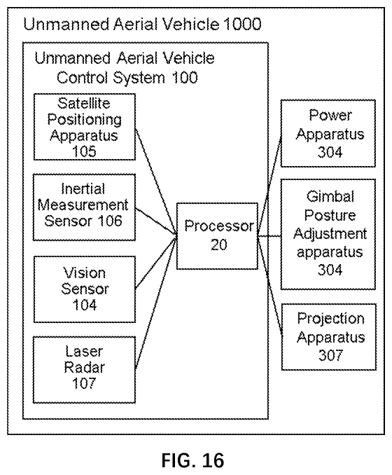

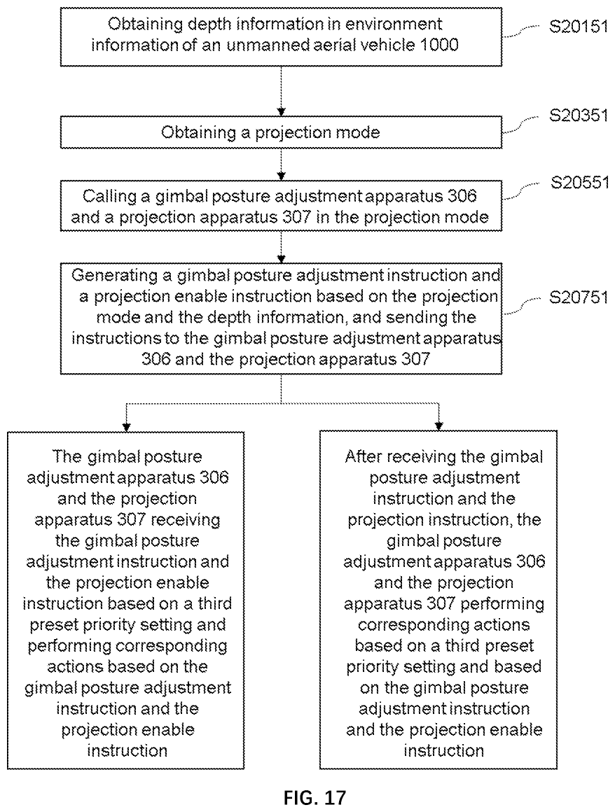

Referring to FIG. 2, FIG. 15, and FIG. 16, In some exemplary embodiments, the unmanned aerial vehicle 1000 may include a gimbal 305, where a gimbal posture adjustment apparatus 306 may be disposed on the gimbal 305. In some exemplary embodiments, the gimbal 305 may be, for example, a tri-axis gimbal, and the gimbal posture adjustment apparatus 306 may include three motors, which are respectively disposed on three-axis frames of the gimbal 305, and configured to adjust a posture of the gimbal to an expected posture. Further, the gimbal carries a projection apparatus 307. After the unmanned aerial vehicle 1000 recognizes the obstacle in the obstacle avoidance mode, the unmanned aerial vehicle 1000 may further enter a projection mode. Referring to FIG. 17, an unmanned aerial vehicle control method in some exemplary embodiments may include the following steps.

S20151. Obtaining depth information in environment information of an unmanned aerial vehicle 1000.

In some exemplary embodiments, in some exemplary embodiments, a vision sensor 104 in a sensing assembly 10 may obtain the depth information in the environment information of the unmanned aerial vehicle 1000, where the depth information is information about a distance between the unmanned aerial vehicle 1000 and an obstacle and angle information. In some exemplary embodiments, the obstacle is a projection screen. In this way, a processor 20 may obtain information about a distance between the unmanned aerial vehicle 1000 and the projection screen and angle information, to obtain an appropriate projection angle. It may be understood that In some exemplary embodiments, the sensing information is not limited to this, for example, may further include other appropriate sensing information such as light intensity information. The information is only an example for description, and is not limited herein.

S20351. Obtaining a projection mode.

Further, the unmanned aerial vehicle 1000 may obtain the projection mode. For example, in some exemplary embodiments, the unmanned aerial vehicle 1000 may further automatically enter the projection mode after obtaining an obstacle avoidance mode. In some exemplary embodiments, the unmanned aerial vehicle may also obtain the projection mode based on an external instruction input by a user. For example, the user may directly obtain the projection mode by inputting. This is not limited herein.

S20551. Calling and/or invoking a gimbal posture adjustment apparatus 306 and a projection apparatus 307 in the projection mode.

After obtaining the projection mode, the unmanned aerial vehicle 1000 may call and/or invoke the gimbal posture adjustment apparatus 306 and the projection apparatus 307 in an execution device in the projection mode, where the gimbal posture adjustment apparatus 306 may be configured to adjust a gimbal 305 to an appropriate position facing the obstacle (that is, the projection screen), and then the projection apparatus 307 may be configured to play projection content.

S20751. Generating a gimbal posture adjustment instruction and a projection enabling instruction based on the projection mode and the depth information, and sending the instructions to the gimbal posture adjustment apparatus 306 and the projection apparatus 307.

In some exemplary embodiments, in some exemplary embodiments, the unmanned aerial vehicle 1000 may send the obtained depth information to the processor 20 of an unmanned aerial vehicle control system 100; and the processor 20 may generate the gimbal posture adjustment instruction and the projection enabling instruction based on the depth information, and may send the instructions to the gimbal posture adjustment apparatus 306 and the projection apparatus 307 in the execution device 300 respectively.

S20951. The gimbal posture adjustment apparatus 306 and the projection apparatus 307 receiving the gimbal posture adjustment instruction and the projection enabling instruction based on a third preset priority setting and performing corresponding actions based on the gimbal posture adjustment instruction and the projection enabling instruction.

In some exemplary embodiments, the gimbal posture adjustment apparatus 306 and the projection apparatus 307 in the execution device 300 may receive, based on the third preset priority setting, the gimbal posture adjustment instruction and the projection enabling instruction sent by the processor 20, and perform the corresponding actions based on the gimbal posture adjustment instruction and the projection enabling instruction. For example, the third preset priority setting may be set in a way that a priority of the gimbal posture adjustment instruction is higher than that of the projection enabling instruction. For example, the gimbal posture adjustment instruction may be first received and executed to control the gimbal posture adjustment apparatus 306 to adjust the gimbal to an appropriate position facing the obstacle (that is, the projection screen), and then the projection enabling instruction is received and executed to turn on the projection apparatus 307.

S20952. After receiving the gimbal posture adjustment instruction and the projection instruction, the gimbal posture adjustment apparatus 306 and the projection apparatus 307 performing corresponding actions based on a third preset priority setting and based on the gimbal posture adjustment instruction and the projection enabling instruction.

In some exemplary embodiments, the gimbal posture adjustment apparatus 306 and the projection apparatus 307 in the execution device 300 may also be configured to perform the corresponding actions based on the third preset priority setting after receiving the gimbal posture adjustment instruction and the projection enabling instruction. For example, the third preset priority setting may still be set in a way that the priority of the gimbal posture adjustment instruction is higher than that of the projection enabling instruction. For example, after receiving the gimbal posture adjustment instruction and the projection enabling instruction sent by the processor 20, the gimbal posture adjustment apparatus 306 and the projection apparatus 307 in the execution device 300 may first execute the gimbal posture adjustment instruction to control the gimbal posture adjustment apparatus 306 to adjust the gimbal 305 to an appropriate position facing the obstacle (that is, the projection screen), and then execute the projection enabling instruction to turn on the projection apparatus 307.

In this way, the unmanned aerial vehicle 1000 can automatically adjust the projection apparatus 307 in the projection mode to an appropriate position and then turn on the projection apparatus to play the projection content.

It may be understood that the unmanned aerial vehicle 1000 may also automatically enter the projection mode after recognizing the obstacle in the obstacle avoidance mode. For example, in some exemplary embodiments, when the processor 20 in the unmanned aerial vehicle control system 100 of the unmanned aerial vehicle 1000 may determine, based on the sensing information, that the obstacle is the projection screen, the unmanned aerial vehicle 1000 may automatically enter the projection mode. The processor 20 may determine, based on a size, surface smoothness, or the like of the obstacle, whether the obstacle is the projection screen. In some exemplary embodiments, alternatively, the unmanned aerial vehicle 1000 may not enter the obstacle avoidance mode, but may directly enter the projection mode. This is not limited herein.

Further, after the unmanned aerial vehicle 1000 may obtain the sensing information obtained by the sensing assembly 10, the unmanned aerial vehicle 1000 may obtain at least one of the control modes based on a second preset priority setting. For example, after the processor 20 of the unmanned aerial vehicle control system 100 may obtain the status information and the environment information of the unmanned aerial vehicle 1000, the unmanned aerial vehicle 1000 may enter at least two control modes. For example, the unmanned aerial vehicle 1000 may enter at least one of the obstacle avoidance mode, an automatic path planning mode, and the projection mode. In some exemplary embodiments, for the control mode, the unmanned aerial vehicle 1000 may first enter the obstacle avoidance mode based on the second preset priority setting, and then determine whether to further enter the automatic path planning mode or the projection mode. For example, a priority of the obstacle avoidance mode may be the highest. It may be understood that the second preset priority setting of the control mode is not limited to this. These embodiments are only examples for description, and are not limited herein.

Further, when control modes selected by the unmanned aerial vehicle 1000 after the obstacle avoidance mode conflict, for example, when the automatic path planning mode and the projection mode conflict, in some exemplary embodiments, the unmanned aerial vehicle 1000 preferentially selects the automatic path planning mode, that is, a priority of the automatic path planning mode is higher than that of the projection mode. In some exemplary embodiments, the unmanned aerial vehicle preferentially may select the projection mode, that is, a priority of the projection mode is higher than that of the automatic path planning mode. In still another implementation, the unmanned aerial vehicle 1000 may further include a control end 400, where a display screen 401 may be disposed at the control end 400, and the display screen 401 may generate a prompt instruction, to prompt the user of a mode conflict, and prompt the user to select a mode to be entered.

It may be understood that the foregoing implementations are all examples for description. In some exemplary embodiments, the unmanned aerial vehicle 1000 may also directly enter the automatic path planning mode or the projection mode without using the obstacle avoidance mode. Further, the unmanned aerial vehicle 1000 may obtain a corresponding control mode based on the sensing information, or may obtain a corresponding mode based on an instruction input by the user, or may further obtain a corresponding control mode based on a combination of the sensing information and an instruction input by the user. This is not limited herein.

Further, after the unmanned aerial vehicle 1000 may obtain and enters the automatic path planning mode or the projection mode, the display screen 401 may further display a flight path of the unmanned aerial vehicle 1000 or the projection content of the unmanned aerial vehicle 1000. This is not limited herein.

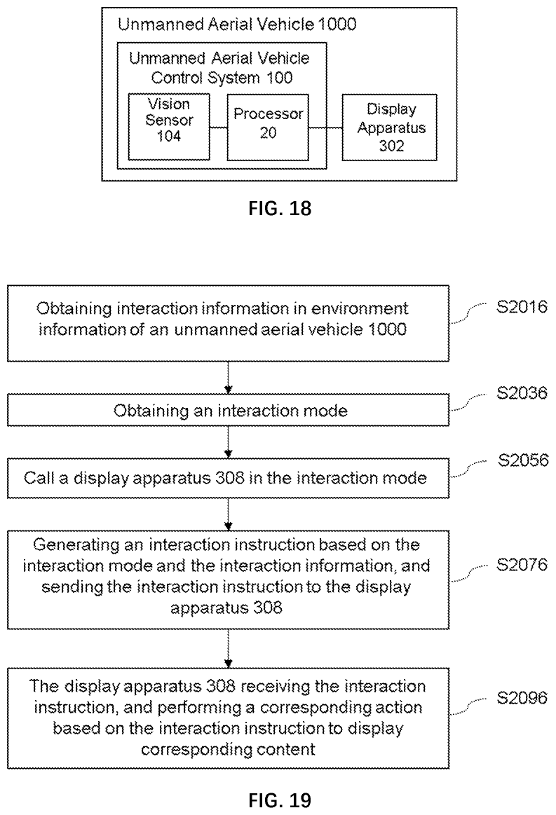

Referring to FIG. 18, in some exemplary embodiments, a sensing assembly 10 of an unmanned aerial vehicle 1000 is a vision sensor 104, where the vision sensor 104 may be configured to obtain interaction information in environment information of the unmanned aerial vehicle 1000. Further, an execution device 10 of the unmanned aerial vehicle 1000 is a display apparatus 308. In some exemplary embodiments, referring to FIG. 19, an unmanned aerial vehicle control method in some exemplary embodiments of the present disclosure may include the following steps.

S2016. Obtaining interaction information in environment information of an unmanned aerial vehicle 1000.

In some exemplary embodiments, a sensing assembly 10 of the unmanned aerial vehicle 1000 may be a vision sensor 104, where the vision sensor 104 may be configured to obtain the interaction information in the environment information of the unmanned aerial vehicle 1000. For example, the interaction information may be information such as a gesture action of a user. The unmanned aerial vehicle 1000 may obtain the interaction information by using the vision sensor 104. It may be understood that the unmanned aerial vehicle 1000 may also obtain the interaction information by using another appropriate sensing apparatus. This is not limited herein.

S2036. Obtaining an interaction mode.

Further, the unmanned aerial vehicle 1000 may obtain the interaction mode. For example, in some exemplary embodiments, the unmanned aerial vehicle 1000 may automatically obtain the interaction mode based on the interaction information. For example, the unmanned aerial vehicle 1000 may be triggered based on a specific interaction action to enter the interaction mode. In some exemplary embodiments, the unmanned aerial vehicle 1000 may also obtain the interaction mode based on an external instruction input by the user. This is not limited herein.

S2056. Call and/or invoke a display apparatus 308 in the interaction mode.

After obtaining the interaction mode, the unmanned aerial vehicle 1000 may call and/or invoke the display apparatus 308 in an execution device 300 in the interaction mode, to display the interaction information. For example, the display apparatus 308 may be an LED matrix disposed in a top position of the unmanned aerial vehicle 1000. It may be understood that In some exemplary embodiments, the display apparatus 308 may be an appropriate display apparatus 308 disposed in an appropriate position of the unmanned aerial vehicle 1000, for example, a flexible display screen. Further, another execution device 300 may also be called and/or invoked in the interaction mode. These embodiments are only examples for description, and is not limited herein.

S2076. Generating an interaction instruction based on the interaction mode and the interaction information, and sending the interaction instruction to the display apparatus 308.

In some exemplary embodiments, in some exemplary embodiments, after obtaining the interaction information in the environment information of the unmanned aerial vehicle 1000, the vision sensor 104 may send the interaction information to a processor 20 of an unmanned aerial vehicle control system 100. Further, the processor 20 of the unmanned aerial vehicle control system 100 may recognize and determine the interaction information, and generate the corresponding interaction instruction. For example, in some exemplary embodiments, after the vision sensor 104 obtains, for example, a gesture action, the processor 20 correspondingly may determine an interaction instruction corresponding to the action, and therefore generate the corresponding interaction instruction based on a determining result. The processor 20 may send the interaction instruction to the display apparatus 308.

S2096. The display apparatus 308 receiving the interaction instruction, and performing a corresponding action based on the interaction instruction to display corresponding content.

In some exemplary embodiments, the display apparatus 308 may display corresponding interaction content based on the interaction instruction. Further, when the display apparatus is, for example, an LED matrix, a corresponding interaction instruction may be to display a corresponding shape in a corresponding position of the LED matrix or display a corresponding color in a corresponding position, to form content such as a corresponding text, an emoticon, or an image. It may be understood that the interaction instruction may be a preprogrammed instruction, so that corresponding content is called and/or invoked in a specific interaction action. In some exemplary embodiments, corresponding content may be displayed directly based on an interaction action. This is not limited herein.

Further, in some exemplary embodiments, the unmanned aerial vehicle 1000 may further include a control end 400, and a display screen 401 may be disposed at the control end 400. In some exemplary embodiments, after the interaction mode is obtained, a prompt instruction may be generated on the display screen 401, to prompt the user that the unmanned aerial vehicle 1000 enters the interaction mode. Further, the display screen 401 may further display the interaction action and/or the content corresponding to the interaction instruction. This is not limited herein.

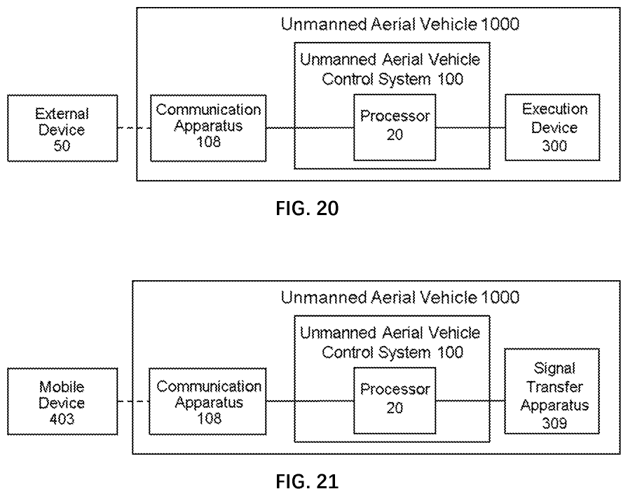

Referring to FIG. 20, in some exemplary embodiments, an unmanned aerial vehicle 1000 may further include a communication apparatus 108, where the communication apparatus 108 may be connected to an external device 50, and the unmanned aerial vehicle 1000 may obtain sensing information from the external device 50 by using the communication apparatus 108.

Further, the external device 50 may include a control end 400. In some exemplary embodiments, the control end 400 may include a mobile device or a remote control apparatus. Further, the control end 400 and the unmanned aerial vehicle 1000 may be connected in a wireless mode. In this case, a user may input a user instruction at the control end 400 such as the mobile device or the remote control apparatus, where the user instruction may be sensing information expected by the user, and the unmanned aerial vehicle 1000 may obtain a corresponding control mode based on the sensing information expected by the user. For example, the user may obtain an alarm mode by inputting sensing information such as location information, luminance information, or temperature information by using the control end 400 such as the mobile device or the remote control apparatus; or the user may directly obtain an alarm mode by inputting, call and/or invoke a corresponding execution device in this mode, and perform a corresponding action. In this way, the user can directly control the unmanned aerial vehicle 1000, to improve user control on the unmanned aerial vehicle 1000, and avoid a danger.

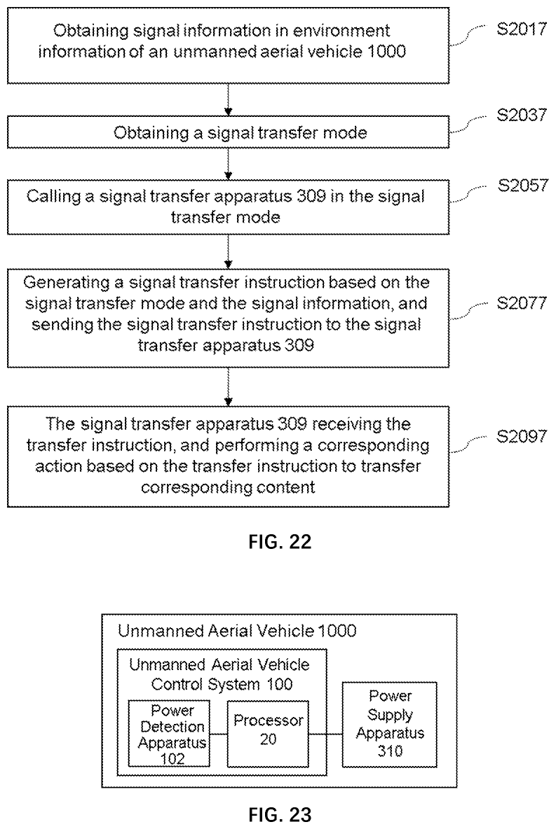

For another example, referring to FIG. 21, in some exemplary embodiments, an external device 50 may be a mobile device 403, an unmanned aerial vehicle 1000 may be connected to the mobile device 403 by using a communication apparatus 108, and the mobile device 403 may be configured to obtain signal information in environment information of the unmanned aerial vehicle 1000. Further, an execution device 10 of the unmanned aerial vehicle 1000 is a signal transfer apparatus 309. In some exemplary embodiments, referring to FIG. 22, an unmanned aerial vehicle control method in some exemplary embodiments of the present disclosure may include the following steps.

S2017. Obtaining signal information in environment information of an unmanned aerial vehicle 1000.

In some exemplary embodiments, a communication apparatus 108 may be connected to a mobile device 403, and the mobile device 403 may be configured to obtain the signal information in the environment information of the unmanned aerial vehicle 1000. For example, the signal may be a marine lamp signal. In some exemplary embodiments, in some exemplary embodiments, the mobile device 403 may obtain the marine lamp signal by using a device such as a photographing apparatus. Further, after obtaining the marine lamp signal, the mobile device 403 may send the marine lamp signal to a processor 20 in an unmanned aerial vehicle control system 100 of the unmanned aerial vehicle 1000.

S2037. Obtaining a signal transfer mode.

Further, the processor 20 of the unmanned aerial vehicle 1000 may obtain the signal transfer mode. For example, in some exemplary embodiments, the processor 20 of the unmanned aerial vehicle 1000 may automatically obtain the signal transfer mode based on the signal information. In some exemplary embodiments, the unmanned aerial vehicle 1000 may enter the signal transfer mode based on an external instruction input by a user. This is not limited herein.

S2057. Calling and/or invoking a signal transfer apparatus 309 in the signal transfer mode.

After obtaining the signal transfer mode, the unmanned aerial vehicle 1000 may call and/or invoke the signal transfer apparatus 309 in an execution device 300 in the signal transfer mode, so that the signal information is correspondingly processed and transferred.

S2077. Generating a signal transfer instruction based on the signal transfer mode and the signal information, and sending the signal transfer instruction to the signal transfer apparatus 309.

In some exemplary embodiments, when the signal information is a marine lamp signal, the processor 20 may translate the obtained marine lamp signal, and send the translated marine lamp signal to the signal transfer apparatus, so that the signal information is transferred.

S2097. The signal transfer apparatus 309 receiving the transfer instruction, and performing a corresponding action based on the transfer instruction to transfer corresponding content.

In some exemplary embodiments, the mobile device 403 may further include a display screen 401. After the processor 20 translates the marine lamp signal, the translated marine lamp signal may be displayed on the display screen 401 of the mobile device 403, so that the user can directly read a meaning of the marine lamp signal. This may improve user experience. It may be understood that the signal information is not limited to the marine lamp signal, and may be other appropriate signal information. A manner of obtaining the signal information is not limited to the photographing apparatus of the mobile device 403, and is not limited herein.

In some exemplary embodiments, the external device 50 may be a predefined website. The unmanned aerial vehicle 1000 may be connected to the predefined website in a wireless communication mode, so that the unmanned aerial vehicle 1000 can obtain sensing information from the predefined website, without using a sensing apparatus for sensing. It may be understood that the external device 50 may be further connected to the unmanned aerial vehicle 1000 in another connection mode, such as a satellite communication connection. This is not limited herein.

In some exemplary embodiments, in some exemplary embodiments, the unmanned aerial vehicle 1000 may obtain meteorological information such as wind speed information, air pressure information, and weather information from a predefined meteorological website in a wireless communication mode, and automatically plan a flight path based on the meteorological information such as the wind speed information, the air pressure information, and the weather information. In some exemplary embodiments, the unmanned aerial vehicle 1000 may obtain air control information from the predefined website, and automatically plan a flight path based on the air control information. In this way, the unmanned aerial vehicle 1000 can implement network-wide convergence, and obtain expected sensing information from the predefined website in real time. Therefore, intelligent highly-efficient flight management may be realized, and user experience may be improved. It may be understood that the unmanned aerial vehicle 1000 may be connected to an appropriate predefined website based on an expectation of the user, to obtain sensing information expected by the user. These embodiments are only examples for description herein, and are not limited.

In some exemplary embodiments, a control end 400 of the unmanned aerial vehicle 1000 may also be connected to the predefined website by using the communication apparatus. In this way, the user may input a user instruction at the control end 400, to obtain, from the predefined website by user inputting, sensing information expected by the user. Further, a display screen 401 may be disposed at the control end 400, and the display screen 401 may display obtained sensing information and/or a control mode, to facilitate visual observation and control by the user, and further improve user experience. This is not limited herein.

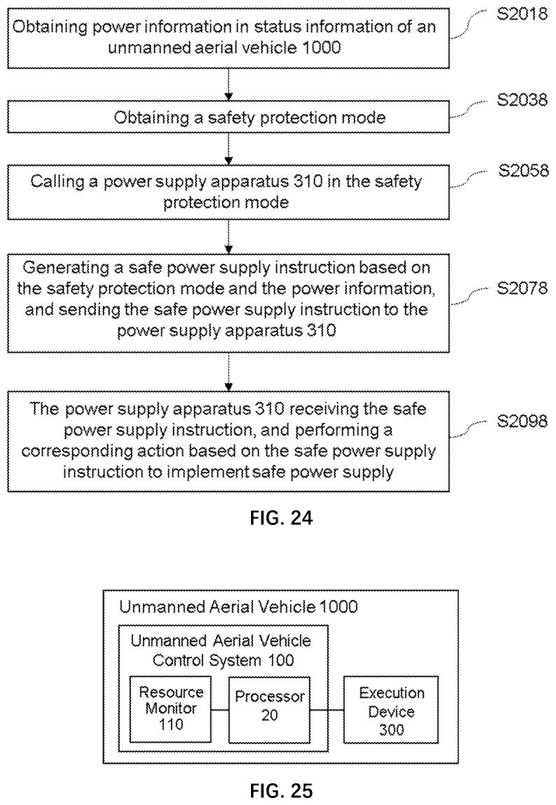

Referring to FIG. 23, in some exemplary embodiments, a sensing assembly 10 of an unmanned aerial vehicle 1000 is a power detection apparatus 109, where the power detection apparatus 109 may be configured to obtain power information in status information of the unmanned aerial vehicle 1000, and an execution device 300 is a power supply apparatus 310. In some exemplary embodiments, referring to FIG. 24, an unmanned aerial vehicle control method in some exemplary embodiments of the present disclosure may include the following steps.

S2018. Obtaining power information in status information of an unmanned aerial vehicle 1000.

In some exemplary embodiments, a sensing assembly 10 may be a power detection apparatus 109, configured to obtain the power information in the status information of the unmanned aerial vehicle 1000. For example, the power detection apparatus 109 may be a power detection apparatus disposed in each battery of the unmanned aerial vehicle 1000, or may be a battery management system that may be disposed in an unmanned aerial vehicle control system 100 and capable of communicating with a battery group. This is not limited herein.

S2038. Obtaining a safety protection mode.

Further, the unmanned aerial vehicle 1000 may obtain the safety protection mode. For example, in some exemplary embodiments, the unmanned aerial vehicle 1000 may automatically obtain the safety protection mode based on the power information, and call and/or invoke a power supply apparatus 310 in an execution device 300 in the safety protection mode. In some exemplary embodiments, the unmanned aerial vehicle 1000 may also obtain the safety protection mode based on an external instruction input by a user. This is not limited herein.

S2058. Calling and/or invoking a power supply apparatus 310 in the safety protection mode.

After obtaining the safety protection mode, the unmanned aerial vehicle 1000 may call and/or invoke the power supply apparatus 310 in the execution device 300 in the safety protection mode. Further, in some exemplary embodiments, the power supply apparatus 310 may be, for example, an intelligent battery or an intelligent battery group.

S2078. Generating a safe power supply instruction based on the safety protection mode and the power information, and sending the safe power supply instruction to the power supply apparatus 310.

In some exemplary embodiments, in some exemplary embodiments, when a power sensing value obtained by the power detection apparatus 109 is less than a preset power threshold, remaining power of the unmanned aerial vehicle 1000 may be insufficient to support safe landing of the unmanned aerial vehicle 1000, and the power sensing value may be sent to a processor 20 of the unmanned aerial vehicle control system 100. The processor 20 may calculate, based on the power sensing value, the safe power supply instruction required for safe landing of the unmanned aerial vehicle 1000. The safe power supply instruction may be sent to the power supply apparatus 310 in the execution device 300.

S2098. The power supply apparatus 310 receiving the safe power supply instruction, and performing a corresponding action based on the safe power supply instruction to implement safe power supply.

In some exemplary embodiments, in some exemplary embodiments, after receiving the safe power supply instruction, the power supply apparatus 310 may perform the corresponding action based on the safe power supply instruction. For example, the power supply apparatus may guarantee power supply for the unmanned aerial vehicle 1000 based on a priority setting, to guarantee flight safety of the unmanned aerial vehicle 1000. For example, in some exemplary embodiments, the unmanned aerial vehicle 1000 may preferentially guarantee power supply for the unmanned aerial vehicle control system 100, a satellite positioning apparatus 105, a power apparatus 304, a vision sensor 104, and the like of the unmanned aerial vehicle 1000, to ensure that the unmanned aerial vehicle 1000 can safely return to an original point or safely land. In some exemplary embodiments, the unmanned aerial vehicle 1000 may be further configured to preferentially supply power for an indication apparatus 301, so that when the unmanned aerial vehicle 1000 does not land at the original point, indication information may be sent out at a landing point, to help the user find the unmanned aerial vehicle 1000. It may be understood that these embodiments are only examples for description. A priority setting of the unmanned aerial vehicle 1000 may be any appropriate sequence. This is only an example for description, and is not limited.

Further, in some exemplary embodiments, the unmanned aerial vehicle 1000 may further include a control end 400, and a display screen 401 may be disposed at the control end 400. In some exemplary embodiments, after the safety protection mode is obtained, a prompt instruction may be generated on the display screen 401, to prompt the user that the unmanned aerial vehicle 1000 enters the safety protection mode.

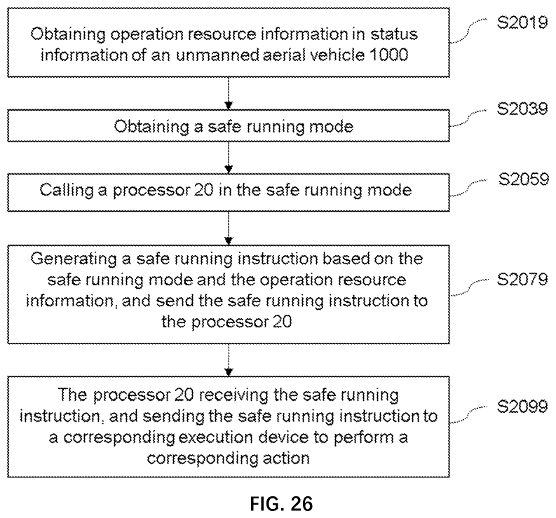

Referring to FIG. 25, in some exemplary embodiments, a sensing assembly 10 of an unmanned aerial vehicle 1000 is a resource monitor 110, where the resource monitor 110 may be configured to obtain operation resource information in status information of the unmanned aerial vehicle 1000. In some exemplary embodiments, referring to FIG. 26, an unmanned aerial vehicle control method in some exemplary embodiments of the present disclosure may include the following steps.

S2019. Obtaining operation resource information in status information of an unmanned aerial vehicle 1000.

In some exemplary embodiments, a sensing assembly 10 is a resource monitor 110, configured to obtain the operation resource information in the status information of the unmanned aerial vehicle 1000.

S2039. Obtaining a safe running mode.

Further, the unmanned aerial vehicle 1000 may obtain the safe running mode. For example, in some exemplary embodiments, the unmanned aerial vehicle 1000 may automatically obtain the safe running mode based on the operation resource information. In some exemplary embodiments, the unmanned aerial vehicle 1000 may also obtain the safety protection mode based on an external instruction input by a user. This is not limited herein.

S2059. Calling and/or invoking a processor 20 in the safe running mode.

After obtaining the safe running mode, the unmanned aerial vehicle 1000 may call and/or invoke the processor 20 in the safe running mode. Further, in some exemplary embodiments, the processor 20 may control running and shutdown of an execution device 300.

S2079. Generating a safe running instruction based on the safe running mode and the operation resource information, and send the safe running instruction to the processor 20.

In some exemplary embodiments, in some exemplary embodiments, when an operation resource information value obtained by the resource monitor 110 is greater than a preset threshold, operations of the unmanned aerial vehicle 1000 may be excessive, and safe working of the unmanned aerial vehicle 1000 cannot be supported. In this case, the operation resource information value may be sent to the processor 20 of an unmanned aerial vehicle control system 100. The processor 20 may calculate, based on the operation resource information value, the safe running instruction required for safe working of the unmanned aerial vehicle 1000.

S2099. The processor 20 receiving the safe running instruction, and sending the safe running instruction to a corresponding execution device to perform a corresponding action.

In some exemplary embodiments, in some exemplary embodiments, the processor 20 may receive the safe running instruction, and send the safe running instruction to the corresponding execution device 300 to perform the corresponding action. For example, the processor 20 may guarantee safe smooth running of the unmanned aerial vehicle 1000 based on a priority setting, to guarantee flight safety of the unmanned aerial vehicle 1000. For example, in some exemplary embodiments, the unmanned aerial vehicle 1000 may preferentially guarantee running of the unmanned aerial vehicle control system 100, a satellite positioning apparatus 105, a power apparatus 304, a vision sensor 104, and the like of the unmanned aerial vehicle 1000, to ensure that the unmanned aerial vehicle 1000 can fly safely. It may be understood that these embodiments are only examples for description. A priority setting of the unmanned aerial vehicle 1000 may be any appropriate sequence, and is not limited herein.

Further, in some exemplary embodiments, the unmanned aerial vehicle 1000 may further include a control end 400, and a display screen 401 may be disposed at the control end 400. In some exemplary embodiments, after the safe running mode is obtained, a prompt instruction may be generated on the display screen 401, to prompt the user that the unmanned aerial vehicle 1000 enters the safe running mode.

In some exemplary embodiments, status information of an unmanned aerial vehicle 1000 may include at least location information, posture information, remaining power information, and operation resource information; environment information may include at least luminance information, temperature information, and interaction information; the control mode may include at least a fill light mode, an obstacle avoidance mode, an alarm mode, an interaction mode, a safety protection mode, and a safe running mode; and the execution device may include at least a fill light apparatus 302, a power apparatus 304, an indication apparatus 301, a power supply apparatus 310, and a processor 20.

Further, in some exemplary embodiments, the processor 20 of an unmanned aerial vehicle control system 100 may make a selection among the fill light mode, the obstacle avoidance mode, the alarm mode, the interaction mode, the safety protection mode, and the safe running mode based on a second preset priority, to generate a corresponding control instruction and implement intelligent outputting of the execution device. For example, the second preset priority may be set as “safe running mode >safety protection mode >fill light mode >obstacle avoidance mode >alarm mode >interaction mode”. It may be understood that the second preset priority setting may be another appropriate priority sorting. These embodiments are only examples for description, and are not limited herein.

In some exemplary embodiments, the processor 20 of the unmanned aerial vehicle control system 100 makes a selection among the fill light mode, the obstacle avoidance mode, the alarm mode, the interaction mode, the safety protection mode, and the safe running mode based on an external instruction, to generate a corresponding control instruction and implement intelligent outputting of the execution device. Further, the external instruction may be input by a user by using a control end 400 such as a mobile device and/or a remote control.

It may be understood that the foregoing descriptions are only preferred embodiments of the present disclosure. Although the preferred embodiments of the present disclosure are disclosed above, the embodiments are not intended to limit the present disclosure. Any other sensing information, control modes, or execution devices 300 applied to the unmanned aerial vehicle 1000, for example, control modes such as an alarm mode obtained based on sensing information such as noise information in the sensing information, shall all fall within the scope of the technical solutions of the present disclosure. For example, the status information and environment information of the unmanned aerial vehicle 1000 may further include other information in addition to the foregoing information, and corresponding control modes may further include other control modes in addition to the foregoing modes. Further, as described above, the sensing information may be obtained based on a first preset priority setting; at least one execution device may receive the control instruction based on a third preset priority setting and perform a corresponding action based on the control instruction, or after receiving the control instruction, at least one execution device performs a corresponding action based on a third preset priority setting and based on the control instruction.

It may be understood that the embodiments are only examples for description, and are not limited herein. Any simple variations, equivalent changes, and modifications made to the foregoing embodiments by a person skilled in the art according to the technical essence of the present disclosure without departing from content of the technical solutions of the present disclosure shall all fall within the scope of the technical solutions of the present disclosure, provided that the changes or modifications to the technical content disclosed above are equivalent changes of equivalent embodiments within the scope of the technical solutions of the present disclosure.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A method for controlling an unmanned aerial vehicle, comprising:
obtaining sensing information of the unmanned aerial vehicle, wherein the sensing information includes at least one of status information of the unmanned aerial vehicle or environment information of the unmanned aerial vehicle;
obtaining at least one control mode;
calling at least one execution device in the at least one control mode;
generating a control instruction based on the at least one control mode and a sensing value of the sensing information;
sending the control instruction to the at least one execution device;
receiving, by the at least one execution device, the control instruction; and
performing, by the at least one execution device, a corresponding action based on the control instruction.

2. The method according to claim 1, wherein the at least one control mode is obtained based on the sensing information or an external instruction input by a user.

3. The method according to claim 1, wherein
the obtaining of the sensing information further includes obtaining the sensing information by a sensing apparatus of the unmanned aerial vehicle based on a first preset priority setting, wherein
the sensing apparatus includes:
at least one of a satellite positioning apparatus, an inertial measurement sensor, a clock, a magnetic field sensor, a pressure sensor, a height sensor, a proximity sensor, a power detection apparatus, or a resource monitor, for measuring the status information, or
at least one of a light intensity sensor, an optoelectronic sensor, an infrared sensor, a vision sensor, a temperature sensor, an anemometer, a barometer, or a sound pressure level sensor, for measuring the environment information,
the status information includes at least one of location information, orientation information, time, acceleration, a speed, a posture, a relative height, a relative distance, power information, or operation resource information, and
the environment information includes at least one of luminance information, ground texture information, depth information, temperature information, interaction information, wind speed information, air pressure information, or noise information.

4. The method according to claim 1, wherein
the obtaining of the sensing information further includes obtaining the sensing information from an external device by a communication apparatus of the unmanned aerial vehicle connected to the external device,
the sensing information obtained from the external device is input by a user, the external device includes a control end, the control end includes at least one of a mobile device or a remote control apparatus, and
the unmanned aerial vehicle is connected to the control end by the communication apparatus.

5. The method according to claim 1, wherein the at least one control mode is obtained based on a second preset priority setting; and
the method further includes: making a selection from two or more control modes based on the second preset priority setting after the two or more control modes are obtained.

6. The method according to claim 1, further comprising:
making a selection between two or more control modes based on an external instruction input by a user after the two or more control modes are obtained, and
generating a prompt instruction after the at least one control mode is obtained.

7. The method according to claim 1, further comprising, after receiving the control instruction:
performing, by the at least one execution device, the corresponding action based on the control instruction and a third preset priority setting.

8. The method according to claim 1, wherein
the environment information at least includes luminance information,
the at least one control mode at least includes a fill light mode,
the execution device at least includes a fill light apparatus called in the fill light mode,
the generating of the control instruction further includes: generating a fill light instruction when a sensing value of the luminance information is less than a preset light intensity threshold,
the sending of the control instruction further includes: sending the fill light instruction to the fill light apparatus,
the receiving of the control instruction further includes: the fill light apparatus receiving the fill light instruction by the fill light apparatus, and
the performing of the corresponding action further includes: performing an action corresponding to the fill light instruction by the fill light apparatus based on the fill light instruction.

9. The method according to claim 8, wherein
the status information of the unmanned aerial vehicle at least includes location information,
the control mode at least includes an alarm mode,
the execution device at least includes an indication apparatus called in the alarm mode,
the generating of the control instruction further includes: generating an alarm instruction when the sensing value of the luminance information is less than the preset light intensity threshold and the location information of the unmanned aerial vehicle is greater than a preset distance threshold,
the sending of the control instruction further includes: sending the alarm instruction the indication apparatus,
the receiving of the control instruction further includes: receiving the alarm instruction by the indication apparatus, and
the performing of the corresponding action further includes: performing an action corresponding to the alarm instruction by the indication apparatus based on the alarm instruction.

10. The method according to claim 8, wherein
the environment information at least includes ground texture information,
the control mode at least includes a precise positioning mode,
the execution device at least includes a power apparatus called in the precise positioning mode,
the generating of the control instruction further includes: generating a posture adjustment instruction based on the ground texture information when the sensing value of the luminance information is less than the preset light intensity threshold,
the sending of the control instruction further includes: sending a posture adjustment instruction to the power apparatus,
the receiving of the control instruction further includes: receiving the posture adjustment instruction by the power apparatus, and
the performing of the corresponding action further includes: performing an action corresponding to the posture adjustment instruction by the power apparatus based on the posture adjustment instruction.

11. The method according to claim 1, wherein
the status information at least includes location information and posture information,
the environment information at least includes depth information,
the control mode at least includes an obstacle avoidance mode,
the execution device at least includes a power apparatus called in the obstacle avoidance mode,
the generating of the control instruction further includes: generating an obstacle avoidance instruction based on the status information and the environment information,
the sending of the control instruction further includes: sending the obstacle avoidance instruction to the power apparatus,
the receiving of the control instruction further includes: receiving the obstacle avoidance instruction by the power apparatus, and
the performing of the corresponding action further includes: performing an action corresponding to the avoidance instruction by the power apparatus based on the obstacle avoidance instruction.

12. The method according to claim 11, wherein
the unmanned aerial vehicle includes a gimbal, the gimbal carrying a projection apparatus,
the control mode includes a projection mode,
the execution device at least includes a gimbal posture adjustment apparatus and the projection apparatus, and the gimbal posture adjustment apparatus and the projection apparatus being called in the projection mode,
the generating of the control instruction further includes: generating a gimbal posture adjustment instruction based on the depth information,
the sending of the control instruction further includes: sending the gimbal posture adjustment instruction to the gimbal posture adjustment apparatus,
the receiving of the control instruction further includes: receiving the gimbal posture adjustment instruction by the gimbal posture adjustment apparatus, and
the performing of the corresponding action further includes:
performing an action corresponding to the gimbal posture adjustment instruction by the gimbal posture adjustment apparatus based on the gimbal posture adjustment instruction,
generating a projection enabling instruction,
sending the projection enabling instruction to the projection apparatus, and
receiving the projection enabling instruction by the projection apparatus to turn on the projection apparatus.

13. The method according to claim 1, wherein
the environment information at least includes temperature information,
the control mode at least includes an alarm mode,
the execution device at least includes an indication apparatus called in the alarm mode,
the generating of the control instruction further includes: generating an alarm instruction, when a sensing value of the temperature information exceeds a preset heat threshold,
the sending of the control instruction further includes: sending the alarm instruction to the indication apparatus,
the receiving of the control instruction further includes: receiving the alarm instruction by the indication apparatus, and
the performing of the corresponding action further includes: performing an action corresponding to the alarm instruction by the indication apparatus based on the alarm instruction.

14. The method according to claim 1, wherein
the environment information at least includes interaction information,
the control mode at least includes an interaction mode,
the execution device at least includes a display apparatus called in the interaction mode,
the generating of the control instruction further includes: generating a display control instruction based on the interaction information,
the sending of the control instruction further includes: sending the display control instruction to the display apparatus,
the receiving of the control instruction further includes: receiving the display control instruction by the display apparatus, and
the performing of the corresponding action further includes: performing an action corresponding to the display control instruction by the display apparatus based on the display control instruction.

15. The method according to claim 1, wherein
the unmanned aerial vehicle at least includes a communication apparatus,
the external device at least includes a mobile device,
the unmanned aerial vehicle is connected to the mobile device via the communication apparatus,
the environment information at least includes signal information,
the control mode at least includes a signal transfer mode,
the execution device at least includes a signal transfer apparatus,
the generating of the control instruction further includes: generating a signal transfer instruction based on the signal information,
the sending of the control instruction further includes: sending the signal transfer instruction to the signal transfer apparatus,
the receiving of the control instruction further includes: receiving the signal transfer instruction by the signal transfer apparatus, and
the performing of the corresponding action further includes: performing an action corresponding to the signal transfer instruction by the signal transfer apparatus based on the signal transfer instruction.

16. The method according to claim 1, wherein
the status information at least includes remaining power information of the unmanned aerial vehicle,
the control mode at least includes a safety protection mode,
the execution device at least includes a power supply apparatus called in the safety protection mode,
the generating of the control instruction further includes: generating a safe power supply instruction based on the remaining power information in the safety protection mode,
the sending of the control instruction further includes: sending the safe power supply instruction to the power supply apparatus,
the receiving of the control instruction further includes: receiving the safe power supply instruction by the power supply apparatus, and
the performing of the corresponding action further includes: performing an action corresponding to the safe power supply instruction by the power supply apparatus based on the safe power supply instruction.

17. The method according to claim 1, wherein
the status information at least includes operation resource information of the unmanned aerial vehicle,
the control mode at least includes a safe running mode,
the execution device at least includes a processor called in the safe running mode,
the generating of the control instruction further includes: generating a safe running instruction based on the operation resource information in the safe running mode,
the sending of the control instruction further includes: sending the safe running instruction to the processor,
the receiving of the control instruction further includes: receiving the safe running instruction by the processor, and
the performing of the corresponding action further includes: sending the safe running instruction by the processor to a corresponding execution device to perform a corresponding action.

18. The method according to claim 1, wherein
the status information includes location information, posture information, remaining power information, and operation resource information,
the environment information includes luminance information, temperature information, and interaction information,
the control mode includes a fill light mode, an obstacle avoidance mode, an alarm mode, an interaction mode, a safety protection mode, and a safe running mode,
the execution device includes a fill light apparatus, a power apparatus, an indication apparatus, a power supply apparatus, and a processor,
the method further includes:
making a selection by the unmanned aerial vehicle among the fill light mode, the obstacle avoidance mode, the alarm mode, the interaction mode, the safety protection mode, and the safe running mode based on an external instruction.

19. A system for controlling an unmanned aerial vehicle, comprising:
a sensing assembly to obtain sensing information of the unmanned aerial vehicle, wherein the sensing information includes at least one of status information or environment information; and
a processor, configured to
obtain at least one control mode,
call at least one execution device based on the at least one control mode,
generate a control instruction based on the at least one control mode and a sensing value of the sensing information, and
send the control instruction to the at least one execution device such that the at least one execution device performs a corresponding action based on the control instruction.

20. An unmanned aerial vehicle, comprising:
a fuselage;
an unmanned aerial vehicle control system disposed on the fuselage; and
at least one execution device disposed on the fuselage,
wherein the unmanned aerial vehicle control system includes:
a sensing assembly to obtain sensing information of the unmanned aerial vehicle, wherein the sensing information includes at least one of status information or environment information, and
a processor, configured to
obtain at least one control mode,
generate a control instruction based on the at least one control mode and a sensing value of the sensing information, and
call at least one execution device based on the at least one control mode, such that the at least one execution device performs a corresponding action based on the control instruction.
